(19) United States
(12) Patent Application Publication
(10) Pub. No.: US 2002/0073167 A1
(43) Pub. Date: Jun. 13, 2002

(54) Internet content delivery acceleration system employing a hybrid content selection scheme

(76) Inventors: Kyle E. Powell, Orem, UT (US); Mark B. Hurst, Highland, UT (US); Karl G. Merkley, Lindon, UT (US)

Correspondence Address: Brian C. Kunzler, 10 West 100 South, Salt Lake City, UT, 84101, US

(21) Appl. No.: 09/733,449

(22) Filed: Dec. 7, 2000

(51) Int. Cl. G06F 15/16

(52) U.S. Cl. 709/217

(57) ABSTRACT

A system and method accelerates the distribution of digital content of a global communications network such as the Internet. A central proxy server selects popular digital objects for transmission over a communication medium to provide content filling of cache databases attendant to local proxy servers. The communication medium may comprise satellite transmission using an IP multicast protocol. The local proxy servers concurrently receive the digital objects at a high rate of speed and store the digital objects in the attendant local cache databases. The local proxy servers may utilize a localized priority determination scheme to determine whether to keep or discard the transmitted digital objects. The priority determination scheme may utilize global demand data and/or local demand data. The demand data may include hits and/or misses on digital objects and may also include quantitative data about the digital objects. The priority determination scheme may be driven by feedback regarding the needs and interests of subscribing users of the local cache database. Consequently, the priority determination scheme and ultimately, the contents of a local cache database, may be unique to that local cache database.

### BACKGROUND OF THE INVENTION

1. The Field of the Invention

The present invention relates to Internet acceleration systems and specifically, to Internet acceleration systems involving satellite transmission and proxy caching to speed up distribution of Internet content.

2. The Relevant Art

The Internet, or World-Wide Web as it is otherwise known, is one of the most significant technological developments of modern times. It provides almost instantaneous transfer of information across virtually the entire globe and enables direct communication between people of different cities, countries, and even continents.

Nevertheless, the Internet is not without its problems. Due to the increasing use and the basic point-to-point nature of the Internet, gridlock has hit. That is, too much Internet traffic and too little bandwidth are substantially slowing down the response times for the transfer of information over the Internet.

One solution that is being developed in response to this problem is caching. Caching involves storing web pages and other frequently accessed digital content at or near the edge of the Internet and close to users at businesses and ISP sites. Moving content to the edge of the Internet in this manner dramatically reduces Internet traffic. With caching solutions, Internet performance is improved through the use of local storage, rather than merely added communication bandwidth. Such arrangements are efficient because the cost of storage is becoming increasingly less expensive, while achieving greater bandwidth remains relatively expensive.

While caching solutions appear promising for boosting Internet performance, two major hurdles to the widespread use of caching currently exist. First, while certain entities such as backbone operators that sell directly to large customers have sufficient “critical mass” to benefit significantly from caching, others, such as businesses and smaller Internet service providers (ISPs), do not. The success of web page caches is a function of “hit rate,” the percentage of requests where the requested digital content is already present in cache. But an enormous amount of digital content is available on the Web and caches servicing smaller populations of varied end users tend to have much lower hit rates than caches servicing large populations of end users.

The second hurdle is that in order to fill current caching systems, the digital content of the cache is required to transit the Internet backbone at least once. Current caching systems typically store the most recently requested digital objects, making place for those objects by displacing the least recently used digital objects in the cache. Subsequent references to objects that are stored in the cache in this manner are then able to avoid traveling across the Internet and consequently have faster access times. Nevertheless, with caches in small Internet communities and their attendant lower hit rates, requested objects are frequently not present in the cache, and those objects must still transit the web getting to the requesting user.

From the above discussion, it can be seen that new solutions for improving the speed of caching on global information networks such as the Internet are needed. For instance, an improved caching system that achieves increased hit rates of digital content within a cache would be a great improvement in the art. An improved manner of extracting web objects and distributing those objects to local caches would also be very helpful. Additionally, the ability to transmit local popularity information to a central location where it can be compiled and used to select web objects for transmission to local caches would also be helpful. It would be particularly helpful to provide an improved manner of locally determining which digital content is likely to be most popular to local users of a particular cache.

### OBJECTS AND BRIEF SUMMARY OF THE INVENTION

The Internet content delivery acceleration system of the present invention has been developed in response to the present state of the art, and in particular, in response to the problems and needs in the art that have not yet been fully solved by currently available Internet content delivery acceleration systems. Accordingly, it is an overall object of the present invention to provide an Internet acceleration system and method that overcomes many or all of the above-discussed shortcomings in the art.

To achieve the foregoing object, and in accordance with the invention as embodied and broadly described herein in the preferred embodiment, an improved Internet content delivery acceleration system and method are provided. Within the system, a central proxy server, or caching system, selects high demand digital objects from the Internet and transmits those digital objects to a plurality of local proxy servers. The transmission of digital objects may be conducted using broadcast, multicast, reliable multicast, unicast, and reliable point to point transport over any suitable medium, including over the electromagnetic waves, fiber optics, and satellite transmission.

In one embodiment, the transmission utilizes a multicast protocol, such as IP multicast transmission from a geo-synchronous satellite. Thus, local content filling of the local proxy servers is provided by transmitting Internet objects to all subscribing local proxy servers at a high rate of speed. Through the use of multicast protocol, only subscribing or interested local proxy servers receive the transmission.

Preferably, the local proxy servers utilize a locally customizable priority determination or heuristic scheme to determine whether to keep or discard the digital objects. The priority determination preferably employs global popularity data, and may also utilize customizable local policies relevant to the particular customers subscribing to the local proxy server.

The local proxy servers are preferably provided with software that enables them to receive the digital objects at the high rate of speed and to store the digital objects in attendant local cache databases for quickly servicing future digital object requests. In one embodiment, the software comprises a cache database management module configured to communicate directly with a cache database. The local proxy server software preferably also comprises a local caching module in integral communication with the cache database management module. Preferably, the integral communication comprises direct communication between programs on a common server or other computer, and may be facilitated by an applications program interface (API).

Because of the tight integration between the cache database management module and the local caching module, sophisticated heuristics determinations may be employed. For instance, rather than simply registering and reporting to the central proxy server when a digital object is requested and is not present in a local cache, customized hit information for all transmitted digital objects and even digital objects that have not been transmitted may also be received from the local cache databases and transmitted to the central proxy server for analysis and use in determining which digital objects to obtain and forward to the local proxy servers. Additional determinations may be made regarding characteristics such as the timing of demand for digital objects, together with the nature of the digital objects for customized determinations of demand within the individual local proxy servers.

When a user requests Internet data, the request is first sent to the local cache database management module to determine whether the requested digital objects is present therein. If the digital objects is present, it is rapidly transmitted to the user directly from the local cache database, without the necessity for transmission over the Internet. If the digital object is not present, a request is transmitted to the central proxy server which requests a copy from the hosting site.

The system may also transmit selected digital objects to subscribing local intranet sites to rapidly and systematically publish private digital objects to local proxy servers connected to the local intranets.

### BRIEF DESCRIPTION OF THE DRAWINGS

In order that the manner in which the advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic block diagram illustrating one embodiment of an Internet content delivery acceleration system of the present invention, including a central proxy server and a plurality of remote proxy servers.

FIG. 2 is a schematic block diagram illustrating a further embodiment of an Internet content delivery acceleration system of the present invention, including private intranet facilities.

FIG. 3 is a schematic block diagram illustrating functional components of one embodiment of software used with the systems of FIGS. 1 and 2.

FIG. 4 is a schematic block diagram illustrating a packet for satellite pointcast to local private intranets.

FIG. 5 is a schematic block diagram illustrating the functional components of one embodiment of a priority determination procedure of the present invention.

FIG. 6 is a schematic flow chart diagram illustrating the operation of one embodiment of software for use on the local proxy server of FIG. 1.

FIG. 7 is a schematic flow chart diagram illustrating the operation of one embodiment of software for use with the central proxy server of FIG. 1.

FIG. 8 is a schematic block diagram illustrating one embodiment of a central proxy server of the present invention.

FIG. 9 is an illustration of the structure of one embodiment of a communications packet suitable for use in conjunction with the present invention.

FIG. 10 is a schematic block diagram of one embodiment of a local proxy server of the present invention.

### DETAILED DESCRIPTION OF THE PREFERRED EMBODIMENTS

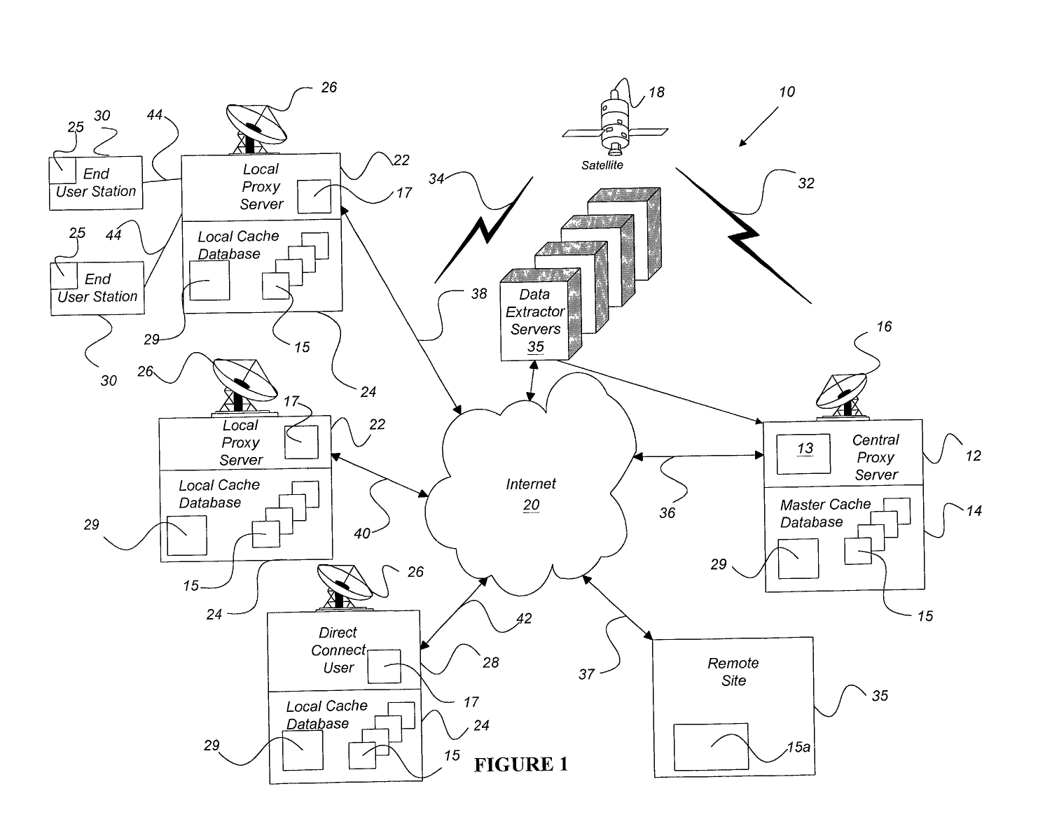

With reference to FIG. 1, shown therein is an Internet content delivery acceleration system 10 of the present invention. Within the system 10 is a central proxy server 12. In one embodiment, the central proxy server 12 comprises a network server 11, such as a personal computer (PC) operating under a network protocol such as IPX. Shown operating within the central proxy server 12 is an attendant master cache database 14. The master cache database 14 is programmed to store frequently used digital objects 15 extracted from the Internet by the central proxy server 12. The digital objects 15 in the embodiment of FIG. 1 comprises Internet web pages 15a. The digital objectsl5 may, however, comprise any form of digital content, including HTML files, video and music files, and any other digitally represented information or data that is capable of being transmitted across a global network.

A central caching module 13 preferably operates within the central proxy server 12. Also included in the depicted embodiment of the system 10 is a plurality of local proxy servers 22, each having a local caching module 17 disposed therein. Each local proxy server 22 also comprises or is otherwise in communication with a local cache database 24. The local proxy servers 22 in one embodiment comprise high-performance, high-capacity PC-based servers. In one embodiment, the local proxy servers 22 operate under an IPX protocol, such as Novell's Netware™. Facilities in which the local proxy servers 22 may be installed include Internet service providers (ISPs), large and medium businesses, and eventually, as economies of scale make the service highly affordable, small businesses and even residences.

The local proxy servers 22 are each provided with a local cache database 24. Preferably, the local cache databases 24 are provided with high capacity memory. In one embodiment, the cache databases 24 are provided with hard drive memory in excess of 40 Gigabytes. A cache database management module 29 is provided in the local proxy servers 22 to interface with the local cache database 24. In one embodiment, the cache database management module 29 comprises an Internet caching system (ICS) program 29, such as Novell Corporation's Border Manager™ and/or ICS™ software. Alternatives include The Traffic Server™ product marketed by Inktomi of Foster City, Calif. Preferably, the local proxy servers are in integral communication with the cache database management modules, as will be described in greater detail below.

The local proxy servers 22 preferably provide users at end stations 30 with access to a global communications network, such as the Worldwide Web existing on the Internet 20. This makes the local proxy servers 22 ideally suited for installation at locations such as ISPs, telephone system switching backbones, points of presence (POPs), and within networks of large companies such as fortune 500 companies. Thus, an end user at a station 30 may be connected to a local proxy server 22 remotely over a modem, or locally over a network 44. The local proxy servers 22 can be considered to be at the “edge” of the Internet 20, a position allowing the present system 10 to reduce traffic over the conventional transmission routes of the Internet 20.

To do so, the local proxy server servers 22 receive and store high-demand digital objects 15 in the attendant local cache databases 24. In an embodiment to be described herein, the digital objects comprise web pages 15a emanating from a remote Internet site 35. The web pages 15a are initially gathered by the central proxy server 12 from Internet sites 35 over a communication channel 36 and are subsequently transmitted from the central proxy server 12 to the local proxy servers 22. The transmission is conducted over a suitable communication medium.

The transmission is referred to herein as a “transmission” over a “communication medium.” Nevertheless, this dissemination of information may include the traditional notions of broadcast, as well as multicast, reliable multicast, unicast, and reliable point to point transport on any suitable medium including over electromagnetic waves, electrical cables, fiber optics and satellite.

Under a preferred embodiment of the present invention, the communication medium comprises transmission by a satellite 18 at a high rate of speed enabled by efficient hard drive data receipt and storage methods encompassed within the present invention. In one embodiment, this rate of speed is about 25 Mbps. A preferred manner of transmission is IP multicast.

The web pages 15a are preferably concurrently transmitted to each subscribing local proxy server 22 once any of the local proxy servers 22 requests the web pages 15a. Each local proxy server 22 receives the web pages 15a and stores them in its local cache database 24 for a selected amount of time before considering whether to purge the particular web pages 15a. In one embodiment, the selected amount of time is scaled to the amount of memory residing in the particular local cache database 22.

The local proxy servers 22 in one embodiment utilize proxy caching protocol built into the HTTP Internet language for proxy servers. Under this protocol, every time a user at a station 30 requests a web page 15a over the network of which the local proxy server 22 is a part, the request passes through the local proxy server 22. As part of the protocol, the local proxy server 22 initially checks its attendant local cache database 24 to determine whether the web page 15a is present. In one embodiment, this consists of the local caching module 17 checking through the integral communication interface with the cache database management program 29.

If the web page 15a is present, the local proxy server 22 immediately transmits the web page 15a through the network 44 to the user at a station 30. Thus, the request is transparent and to the user at a station 30, it appears as if the web page 15a was transmitted over the Internet 20. Advantageously, by bypassing the Internet 20, the transmission is much more rapid. Additionally, Internet traffic is reduced, and Internet connection costs are potentially much lower.

If the requested web page 15a is not present in the local cache database 24, the HTTP caching protocol causes the request to be passed on through the Internet 20 to the Internet site 35 at which the web page 15a is hosted. The Internet site 35 then transmits the web page 15a over the Internet 20 back to the requesting user at a station 30. This Internet transmission occurs over regular Internet communication channels 38, 40, 42.

Concurrently, the request is also passed to the central proxy server 12. Once the central proxy server 12 receives its copy of the request, it also requests a copy of the requested web page 15a from the hosting Internet site 35. Accordingly, the web page 15a is also transmitted over channels 36, 37 to the central proxy server 12. Once the web page 15a is received by the control proxy server 12, the central proxy server 12 caches the web page 15a within the attendant master cache database 14. The central proxy server 12 may also multicast the web page 15a to the communicating local proxy servers through the communication medium if the web page 15a is found to have a sufficiently high priority. The communication medium in one embodiment is satellite transmission. The web page 15a is transmitted 32 through a satellite uplink transmitter 16 to the satellite 18 at a speed of, for example, 25 Mega bytes per second (Mbps). The satellite 18 then transmits 34 the web page 15a to each of the subscribing local proxy servers 22, at a high rate such as 25 Mpbs.

The central proxy server 12 may filter the web page 15a before caching it. It may also keep track of the number of requests for the web page 15a and transmit web pages 15a (or other digital objects 15) only after a certain minimum number of requests have been logged for that web page 15a. Accordingly, the central proxy server 12 is in a position to be a ratings system for the Internet 20, having centralized access to web site demand information.

Additionally, the central proxy server 12 preferably receives global popularity information about digital objects 15 from subscribing local proxy servers 22. This popularity information in a basic embodiment comprises miss data. Additionally, due to the unique configuration of the present invention, more sophisticated information may also be transmitted. This may include, for instance, hit information and timing information, as will be discussed in greater detail below.

The central proxy server may also utilize digital object popularity information, digital object characteristics, data associations, and other data useful to local proxy servers 22 in deciding which extracted digital objects 15 to continue to store. Such information may be collected from the local proxy servers 22, and in addition, may also be received from companion digital object extractor servers 35 communicating with the central proxy server 12.

The digital object extractor servers 35 preferably locate information relevant to the priority determinations of the local proxy servers 22 and pass that information to the central proxy server for compilation and later transmission to the local proxy servers 22 and optionally, to other requesting entities, possibly for a subscription fee. Manners in which this information may be gleaned include directly contacting web sites that contain hit rates or other popularity information. Additionally, the digital object extractor servers 35 may themselves traverse or “crawl” over the web to examine web sites and observe traffic. When examining web sites, the digital object extractor servers 35 may follow links on those web sites to other web sites to similarly examine the other web sites. This process may be continuous, and the information that is gathered is preferably passed to the central proxy server, as stated.

Additional information that may be collected by the central proxy server 12 includes the qualitative information regarding the digital objects 15, rather than just quantitative data. Thus, types of digital objects 15 may be collected, either from the local proxy servers 22 or from the digital object extractor servers 35. This data may include, for instance, the subject matter of the digital objects 15, the types of sites requesting the digital objects 15, etc. This information may then be used by the local proxy servers 22 in making a customized priority determination according to local demand and local user types.

In the depicted embodiment, a single central proxy server services the entire system 10. Nevertheless, more than one central proxy server 12 may be in operation. For example, different geographical locations may be served by different central proxy servers 12. These multiple central proxy servers 12 may be in communication with each other either through suitable mediums and may share information such as hit and miss rate information and other useful content selection information.

Each local proxy server 22 is preferably provided with a communication facility, such as a satellite down-link receiver 26. In the depicted embodiment, the down-link receiver 26 receives the satellite multicast transmission 34 of the extracted web pages 15a. Upon receiving the web page 15a, each subscribing local proxy server 22 caches the web page 15a for a selected period of time for access by users at the communicating stations 30. At the end of the selected period of time, each local proxy server 22 preferably utilizes an individualized local policy and a priority determination program to determine whether to keep or discard the transmitted web page 15a.

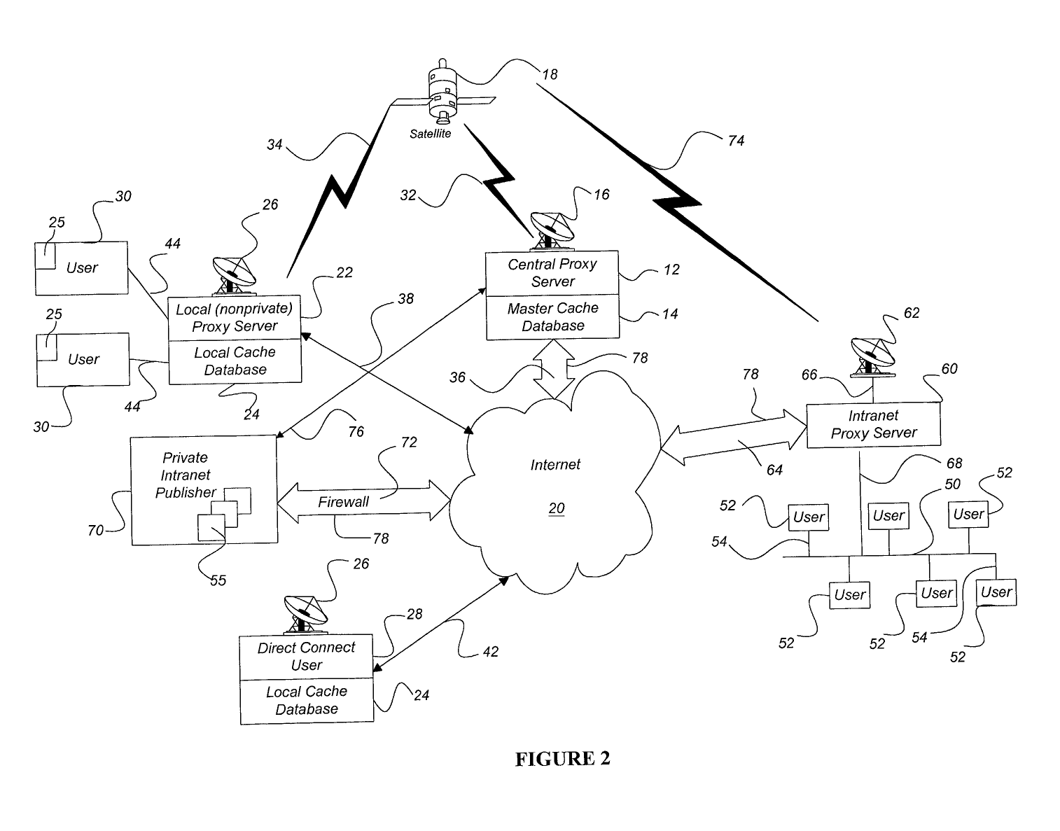

Reference is now made to FIG. 2 for a discussion of a further aspect of the present invention. In addition to multicasting generally to a series of local proxy servers 22, the central proxy server 12 may also service one or more virtual private intranets 50 through selective pointcast satellite transmission 74. Under this concept, and in an embodiment to be specifically described herein, the system 10 preferably operates in substantially the same manner as described above. Accordingly, the system 10 is provided with the central proxy server 12 and a series of local proxy servers 22 configured substantially in the manner described. In addition, the system 10 may also be provided with the private intranet 50. The private intranet 50 is shown communicating over the Internet 20 through an intranet proxy server 60. The intranet proxy server 60 may also function as a local proxy server 22, as discussed above.

As depicted, the private intranet 50 connects to end users at remote stations 52 through a communication channel 54. The private intranet 50 is connected with the intranet proxy server 60 through a communication channel 68. The Intranet proxy server is in communication with a satellite down-link receiver 62 through a communication channel 66 and with the Internet 20 with a communications channel 64. One or more of the aforementioned channels may maintain security with a firewall 78.

The system 10 may also be provided with a private intranet publisher 70 for generating or otherwise providing private digital objects 55 to be communicated to users at stations 52 within the private intranet 50. In the depicted embodiment, the private intranet publisher 70 is a dedicated server computer communicating over the Internet 20 through a secure channel 72. The secure channel 72 is shown provided with a firewall 78.

The private intranet publisher 50 generates or collects the private digital objects 55, which may be business, financial, or any other type of data, and transmits the private digital objects 55 in web page form. The private digital objects 55 is passed in a secure manner through the Internet 20 to the central proxy server 12. The central proxy server 12, through a satellite uplink transmitter 16, then uplinks 32 the private digital objects 55 to the satellite 18. The satellite 18 then transmits the private digital objects 55 to intranet proxy servers 60 of the subscribing virtual private intranet using a focused multicast 74. The same satellite 18 may also transmit 34 other digital objects such as web pages 15a to the regular local proxy servers 22.

All private intranet transmission over the Internet 20 is preferably kept within a firewall 78, preferably through hashing or other encryption of the digital objects being transmitted. The multicast transmission 74 could be transmission by a private frequency, or more preferably, through the same frequency and channels as the normal web site multicasts 34, but with a header placed on each transmitted packet identifying the transmission as private and identifying the designee. In such a case, encryption may be employed, and the remote intranets intended to receive the digital objects may be provided with encryption keys. A master key is preferably retained by the central proxy server 12. Local proxy servers 22 for which the private digital objects 55 is not intended thus ignore the digital objects 55. The header could also particularly specify whether the digital objects is private digital objects 55 or global digital objects 15.

Thus, the Virtual Private Intranet of the present invention, unlike prior art broadcast intranets, is one-way, and the private digital objects 55 to be transmitted are collected or otherwise designated by the central publisher 70. In one embodiment, the publisher 70 collects private digital objects 55 as a result of requests from remote intranet sites, possibly over the Internet 20.

One example of the use of a virtual private intranet 50 of the present invention is within a car dealership chain. In such a case, private digital objects 55 such as, for example, sales and pricing data may be transmitted over the virtual private intranet 50. Financial advising companies may also use the system and pointcast 74 digital objects 55 in the form of market data or financial analysis in another example. Banks may make financial transactions with the system 10. As a further example, businesses might transmit sales information, company policies, advertising materials, etc., over the virtual private intranet 50.

It is preferred that the private digital objects 55 are pointcast 74 transparently to the users 52. Thus, the digital objects 15 may be viewed using the file transfer protocol of the local network, rather than as an Internet URL site. Accordingly, users 52, though possibly located across the world from each other, may access the private digital objects 55 from the proxy server as if the objects 55 are a local part of the remote intranet 50. The private digital objects 55 may be transmitted on demand, but it is contemplated that at least a substantial portion of the private digital objects 55 may be transmitted through the discretion of the Internet publisher 70, or may comprise standard information, periodically updated and transmitted.

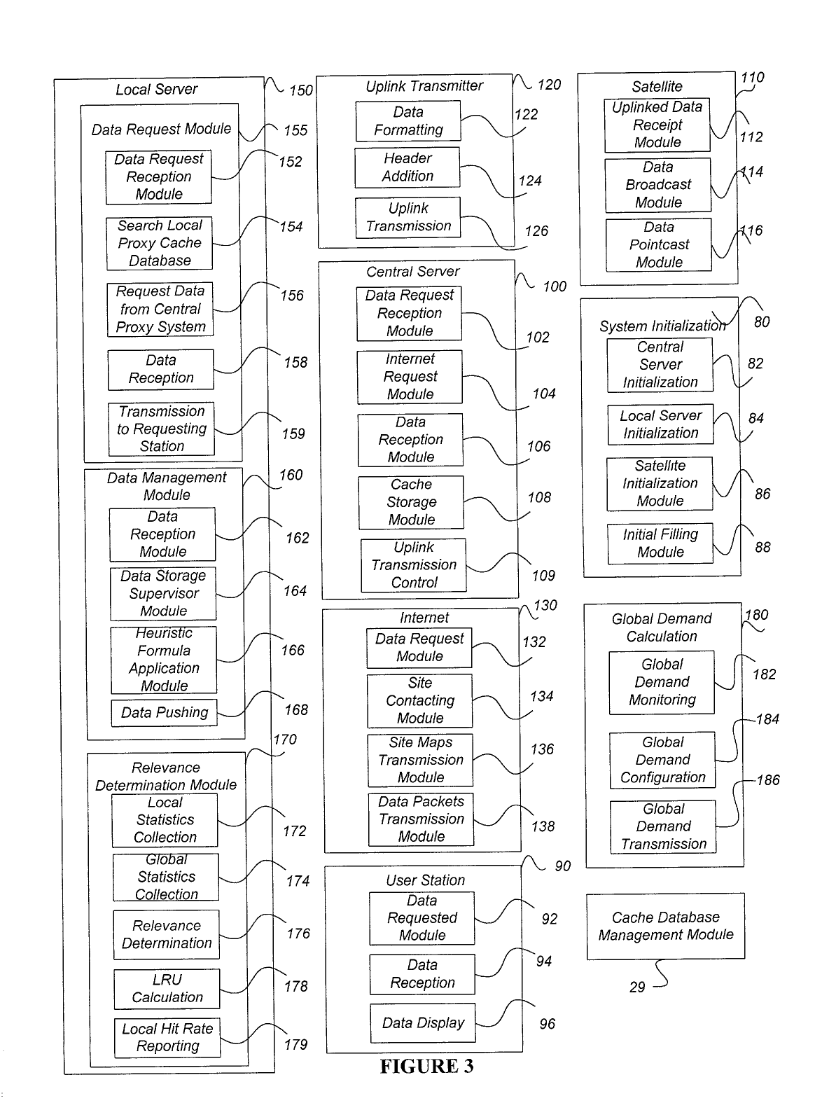

Referring now to FIG. 3, shown therein is a schematic block diagram illustrating more specifically the various functional components of one embodiment of software used to enable the system 10 of the present invention. The software modules contained in the schematic block diagram of FIG. 3 are generally implemented as software instructions, procedures, routines, or other executable software code. Nevertheless, the modules could also be implemented with other types of programmable logic such as programmable logic arrays (PLAs), ASICs, or even logic circuits or other types of hardware.

In order to initialize the system 10 (of FIGS. 1 and 2) and enable communication links, the depicted components of a system initialization block 80 is employed. The modules of the system initialization block 80 may be contained as software code within the central proxy server 12, or may be distributed amongst the different hardware components of the system 10. Initially, the central proxy server 12 is initialized and brought on-line with a central server enablement module 82. This preferably includes enabling Internet communication over communication channel 36 and enabling satellite communication with the satellite uplink transmitter 16.

Subsequently, the local proxy servers 22 are enabled and brought on-line with a local proxy server enablement module 84. Typically, Internet communications are enabled through communication channels 38, 40, and 42. It is of note that the various local proxy servers 22 will generally not all be brought on-line at one time. Typically, the system 10 of the present invention will be provided commercially as a service to which customers subscribe. As new customers subscribe, they are provided with the local proxy server 22 and satellite receiver hardware 26 for an initial fee. A monthly subscription fee may be charged thereafter.

Satellite communications are enabled with a satellite initialization module 86. This may include establishing the communications link between the satellite 18 and the satellite uplink transmitter 16 and between the satellite 18 and the satellite receivers 26, 62. It may also include establishing a proper protocol for satellite communications. For the embodiment of FIG. 2, satellite communications for the pointcast transmission must be established with one or more Internet proxy servers 60.

The intent of the system 10 is to fill the local cache databases 24 of each subscribing local proxy server 22 with the most highly requested digital objects such that the majority of requests for web pages 15a may be serviced directly by the local proxy servers without having to resort to the Internet 20. Accordingly, each new central proxy server that is brought online must be initially filled with high demand web content 15a. An initial filling module 88 and may be utilized for this purpose and may function in a variety of manners. In one contemplated embodiment, the central proxy server 12 transmits “old” digital objects that have been previously transmitted in between transmitting “fresh” digital objects that have only recently been requested. This transmission may be conducted in bursts to transmit the entire contents of the master cache database systematically, or according to a selected heuristic formula.

A user station block 90 of FIG. 3 illustrates the basic functional components and operation of a user station 30 of FIG. 1. Through an Internet digital object request module 92, the user at the end station 30 places a request for a digital object 15. In one embodiment, the digital object 15 is a web page 15a and the digital object request module comprises a standard web browser 25 which is connected to the Internet through a local proxy server 22. The digital object 15 is transparently received from the local proxy server 22 through a digital object reception module 94. The digital object reception module 94 may comprise the web browser 25 in conjunction with the HTTP proxy caching protocol which searches local cache databases 24 prior to transmitting a request for Internet data over the Internet 20.

Once the web page 15a is received, either from the local cache database 24 or over the Internet 20, it is displayed to the user with a digital object display module 96. The digital object display module 96 in one embodiment comprises the web browser 25 together with the proxy caching protocol of the HTTP language operating on a PC or other computer.

A central server block 100 illustrates the basic functional components operating within the central proxy server 12 of FIG. 1. These components are preferably part of a central caching module 13 of FIG. 1. A digital object request reception module 102 allows the central proxy server 12 to receive the request for a digital object made by the user at a station 30 with the digital object request module 92. An Internet request module 104 passes the request on through the Internet 20. A digital object reception module 106 receives the digital object 15 transmitted by the Internet 20 in response. A cache storage module 108 receives the requested digital object 15 and stores a copy of the digital object 15 within the master cache database 14. An uplink transmission control module 109 coordinates with the communication network to distribute selected data 15 to the local proxy servers 22. In one embodiment, the uplink transmission control module 109 communicates with the satellite transmitter 16 in transmitting digital objects 15 through the uplink 32 to the satellite 18. Of course, other types of transmission could be utilized, including transmission over the Internet itself.

A satellite operation block 110 illustrates the basic operation of functional modules operating within the satellite 18 of FIGS. 1 and 2. Once the web page 15a has been uplinked by the central proxy server, the satellite 18, an uplink reception module 112 receives the uplinked web page 15a or other digital object 15. Subsequently, a digital object transmission module 114 formats and transmits the digital object 15 through satellite multicast 34 to all associated local proxy servers 22. Additionally, if the uplinked digital object 15 contains private digital objects 55, a pointcast data module 116 formats and pointcasts the private digital objects 55.

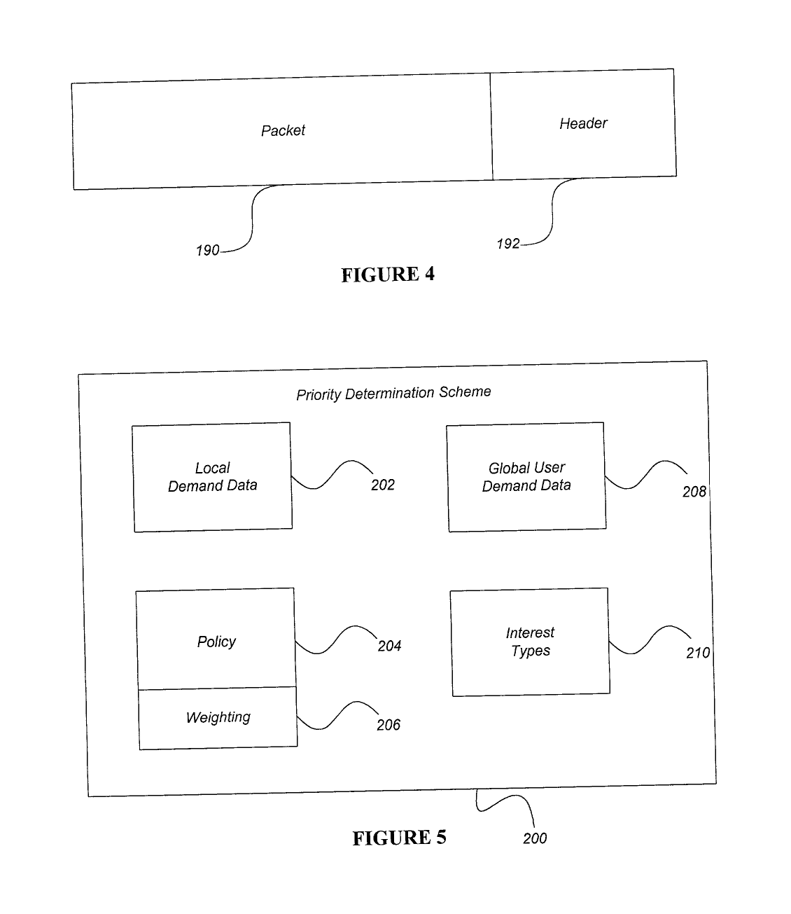

An uplink transmitter block 120 of FIG. 3 illustrates general functional modules operating within the satellite uplink transmitter 16 of FIGS. 1 and 2. The digital object 15 to be uplinked is formatted into a proper form and protocol for satellite transmission with a digital object formatting module 124. Header information is added to the packets to be uplinked with a header addition module 124. One simplified example of the structure of a packet 190 is shown in FIG. 4. A typical packet 190 is comprised of data 191 preceded by a header 192. The uplink transmission is conducted between the satellite uplink transmitter and the satellite 18 with the use of an uplink transmission module 126.

An Internet block 130 illustrates one example of the functional modules operating within the Internet 20 of FIGS. 1 and 2. Requests for digital object 15 are transmitted over the Internet 20 with a digital object request module 132. The request is typically the request generated by the Internet request module 104. Once the digital object 15 is requested, the Internet site 35 at which the digital object 15 is hosted is contacted with a site contacting module 134. A site map of the site, including the location and configuration of the web page 15a is transmitted from the web site 35 with a site map transmission module 136. Thereafter, the web page 15a is transmitted from the Internet site 35 to the central proxy server 12 with a digital object packet transmission module 138. The web page 15a and attendant site map may also be transmitted directly to the requesting local proxy server 22.

A local server block 150 illustrates one embodiment of the functional components operating within the local proxy server 22 of FIGS. 1 and 2. Preferably, these functional components are contained within the local caching module 17 of FIG. 1. Within the local server block 150, a digital object request block 155 includes a digital object reception module 152. The digital object reception module 152 receives requests for digital object 15 from the end users at the stations 30. Generally, this request is generated by the digital object request module 92. A search module 154 searches the local cache database 24 for the requested digital object 15. In one embodiment, the search module 154 comprises the proxy cache protocol employed within the HTTP language.

If the requested digital object 15 is not present within the local cache database 24, a digital object request module 156 transmits a request for the digital object 15 to the central proxy server 12. This request is typically routed over one of the communication channels 38, 40, or 42, through the Internet 20, and through communication channel 36 to the central proxy server 11. The request may comprise the original request received from the user at a station 30 modified with the Internet URL of the central proxy server 12. Concurrently, the digital object request module 156 may also request the digital object 15 directly from the Internet site 35 where the digital object 15 is hosted.

A digital object reception module 158 receives the requested digital object 15. Typically, the digital object 15 is provided by the central proxy server 12 in accordance with the procedure discussed for the central server module 100. Thus, the digital object 15 is uplinked 32 to the satellite 18, which multicasts the digital object 15 to all subscribing local proxy servers 22. The digital object 15 is received by the satellite receiver 26 and passed to the local proxy server 22. The local proxy server 22 may also receive the digital object 15 directly over the Internet. The digital object 15 from the earliest arriving of the multicast 18 and the direct Internet transmission is then passed on to the user at the station 30.

A digital object management block 160 illustrates the functional components of the local proxy servers 22 which handle the digital object 15 received from the satellite transmission 34. When a digital object 15 is requested by a user station 30 and is found to not be present within the attendant local cache database 24, a request is made for the digital object to the central proxy server 12, as discussed. That digital object 15 is then requested from the Internet site 35 where it is hosted, as also discussed, and then transmitted through satellite transmission 34 to the local proxy server 22 requesting the data. Concurrently, the digital object is also received by the satellite receivers 26 of all other subscribing local proxy servers 22 with the use of the digital object multicast reception module 162 which is preferably programmed into each of the local proxy servers 22. Typically, all of the satellite receivers 26 are attuned to the same frequency over which the digital object 15 is transmitted. Of course, if a number of satellites 18 are used to transmit the digital object 15 around the world, a number of different frequencies may also be employed.

Once the digital object 15 is received, a digital object supervisor module 164 operating within each of the local proxy servers 22 attends to the storage of the digital object 15 within the local cache database 24. The digital object 15 is automatically stored for a predetermined amount of time. In one example, the predetermined amount of time may be is a period of four hours. Once that time has passed, a priority determination application module 166 conducts a priority determination to determine whether to continue to store or to discard the digital object 15. If, after application of the priority determination, it is decided that the likelihood of a request for the digital object 15 is low for that particular local proxy server 22, a push module 168 discards the digital object 15, removing it from the local cache database 24. In one preferred embodiment, each local proxy server 22 is provided with its own, individualized priority determination scheme.

In one embodiment, the modules 158, 160 integrally communicate with a cache database management module such as Novell's ICS™ software, which in turn attends to the storage of the digital object 15 onto disk at the high rate of speeds specified, and/or Novell's Border Manager™ software which acts as a proxy cache manager and provides proxy content filling and firewall functions.

A local relevance determination block 170 illustrates the functional components of one embodiment of a priority determination scheme of the present invention. A local statistics collection module 172 resident within each local proxy server 22 monitors the frequency of requests for each file of digital object 15 located within the local cache database 24. A global statistics reception module 174 receives digital object demand statistics from a central location. In one embodiment, the central location is the central proxy server 12, which collects demand statistics during the process of servicing requests for digital objects 15. In this manner, the central proxy server 12 acts as a sort of “Nielsen Ratings Service” for the Internet. This information may be provided either free or for a fee to interested parties as will be discussed in grater detail below.

A priority determination module 176 utilizes the statistical information gathered by modules 172 and 174 in making the priority determination of whether to keep a particular digital object 15. If the determination is to keep the digital object 15, a least recently used (LRU) module may be used to decide which existing digital object is to be discarded to make room for the new digital object 15. The LRU calculation module 178 calculates the amount of use of each file of digital object 15 and adds a local use factor into the determination. This priority determination is applied by the priority scheme application module 166 as described above.

The priority determination module 176 preferably utilizes localized web page demand statistics compiled by the local proxy server 22 as well as globalized web page demand statistics collected by and transmitted periodically from the central proxy server through satellite transmission.

A hit rate reporting module 179 periodically reports the local hit rates for part or all of the digital objects 15 transmitted from the central proxy server 12. This information is used to calculate global demand statistics. Preferably, each participating local proxy server 22 tabulates every request from every end user station 30. A hit report is then periodically transmitted to the central proxy server 12. The central proxy server 12 in turn tabulates the accumulated hit reports for all web pages requested and periodically sends updated usage information with the hit totals to the local proxy servers 22. Preferably, every digital object 15 is assigned a globally unique identification number which can be stored and transmitted compactly and which is used to identify the particular digital object 15.

It is preferred that the relevance determination module 170 is closely integrated with the digital object management module 160. In one embodiment, the digital object management module 160 is implemented through tight integration with the cache database management module program 29 and the priority determination module is configured to work closely with the cache database management module 29.

In one embodiment, the digital object management module 160 keeps track of related files within a web page 15a or related to a web page 15a. The related files may be uplinked and transmitted together through satellite transmission 34. The relevance determination module 170, being integrated with the digital object management module 160, may be configured to receive a list of the objects and files associated with a page. In this manner, the local digital object relevance determination module 170 may able to ensure that the related digital objects stay together and are stored together in the local cache database 24. It may also calculate usage information for each of the objects and files separately and keep all associated files or “trim” a portion of the objects and files that are not highly used. The related files may then be transmitted as a group when one or more of the related files is requested by a user at a communicating station 30.

Additionally, the local relevance determination module 170 may also track “supergrouping” of web page information 15. In many web pages, information such as advertisements change or alternate back and forth. These changes may be kept track of and the differing versions transmitted together by the central proxy server 12.

One example of a manner of configuring the relevance determination module 170 is illustrated in FIG. 5. Shown therein is relevance determination module 170 containing a local demand data module 202. In addition, each local proxy server 22 may also have a custom local policy 204. Within the policy 204 is a relative weighting 206 of local and global web page demand. This policy 204, the local demand data 202, as well as global demand data 208 are preferably employed by the priority determination module 200 to determine whether to keep or discard each separate digital object 15 that is received, once the selected period of time has passed. The policy 204 may also weight various subject matters attributed to the web pages 15a. The policy 204 may also include other local value factors, such as the ease of getting the digital object 15 for the particular local proxy server 22.

The policy 204 may also specify the particular interest areas that the priority determination scheme is intended to weight. For instance, in a case where the local proxy server 22 services a school, the policy 204 may give greater weight to digital objects 15 containing educational issues. As a further example, if the local proxy server 22 services a research institution, the policy 204 may give greater weight to digital objects 15 relating to the particular research being conducted.

Thus, as shown in a global demand calculation block 180 of FIG. 3, a global demand monitoring module 182 resident within the central proxy server 12 monitors the requests for information from each local proxy server 22. It also monitors the hit rate data transmitted by the reporting modules 179 of each local proxy server 22. In response, a global demand compilation module compiles the data collected by the global demand monitoring module 182. Within those statistics may be information relevant to each particular subject matter such that the priority determination schemes may take the categorized demand data into account according to the particular weighting of the subject categories in their local policies 204.

A particular subscribing local proxy server 22 might be an educational institution, business, or news provider, and might weight subject matter statistics from relevant categories more heavily within its own local policy 204 than others of the local proxy servers 22. A global demand transmission module 186 transmits the demand data, preferably by satellite transmission 34, in the same manner that the requested digital object 15 is transmitted.

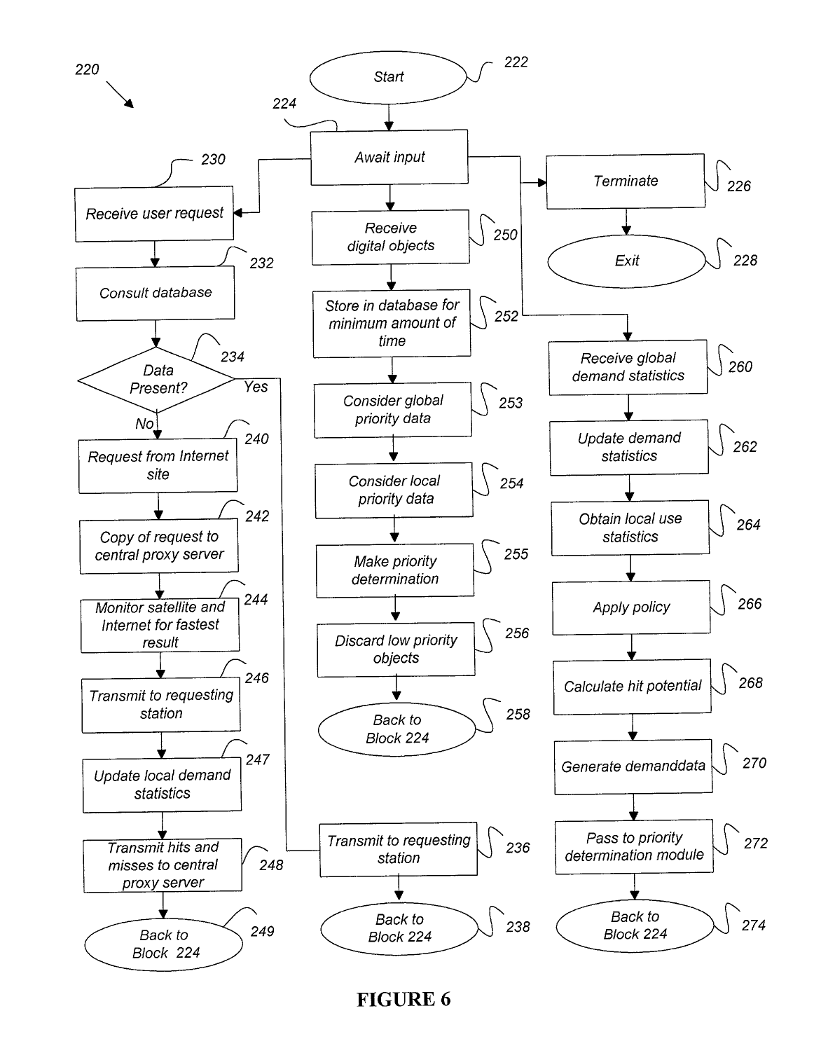

FIG. 6 is a schematic flow chart diagram illustrating one manner of operation of a software program 220, a copy of which preferably operates on each subscribing local proxy server 22. In one embodiment, the software program 220 corresponds to the local caching module 17. The program 220 initializes at a start block 222 then proceeds to a block 224, where it awaits receipt of input to be processed. Input may be received in the form of a terminate command, which is received at a block 226. The program 220 then progresses to an end block 228, where it terminates.

Several additional functions may also be accomplished by the program 220. For instance, in one embodiment, the program 220 may receive a user request for a digital object 15, as depicted at a block 230. The program 220 then proceeds to a block 232, where the caching protocol of the HTTP language is utilized to consult the local cache database 24 and thereby determine if the requested digital object 15 is present. At a query block 234, the program 220 branches in one of two directions, depending on whether or not the digital object 15 is present in the local cache database 24. If the digital object 15 is present, the program 220 proceeds to a block 236 where it transmits the digital object 15 to the requesting station 30 for presentation to the user. The program then proceeds to a block 238, where control of the program is returned to the start block 222.

If the digital object 15 is not present, the program 220 proceeds from the query block 234 to a block 240, where it passes the request on through the Internet 20 to the hosting site 35. At about the same time, the program 220, at a block 242, transmits a copy of the request to the central proxy server 12. The program 220 then waits at a block 244 for the requested digital object 15 to return by way of the fastest route, whether it be through satellite transmission 34 or through the Internet 20. Once the digital object 15 is received from the fastest route, the program 220 transmits the digital object 15 to the requesting user station 30 for presentation to the user. Thereafter, the program 220 moves to a block 247 where local demand statistics are updated.

At a step 248, the local proxy server 22 transmits hit information to the central proxy server 12. Miss information, resulting from a request for which nor corresponding object 15 is present in the local proxy cache 24, is communicated to the central proxy server 12 by the request of step 242. In addition, the local proxy server 22, preferably through the integral interface with the cache management module 29, may be configured to transmit miss information to the central proxy server 12 for compilation into global demand data. In one embodiment, hits are compiled into a file which is of a certain size. When the file is full, or at selected intervals, the miss report is transported across the Internet 20 to the central proxy server 12. All local proxy caches 22 in one embodiment continually send such reports, acting as the eyes and ears of the system 10. The local caching module 17 may also compile reports of hits and misses for use in determining local relevance of objects transmitted from the central proxy server 12. Subsequently, the program moves to a block 249 where control is passed back to the receive input block 224.

The program 220 may also receive as input the transmission of web pages 15a or other digital objects 15 from the central proxy server. In one embodiment, the digital object 15 is received at a block 250. The program 220 then proceeds to a block 252 where it stores the received digital object 15 in the local cache database 24 for a selected amount of time. After the selected amount of time has passed, the program 220 generates feedback data utilizing the priority determination scheme 200 of FIG. 5, and makes a determination of whether to retain or discard the digital object 15. Preferably, this priority determination is localized to the particular local proxy server 22, and may take the form of a local relevance determination. Of course, the priority determination could be made prior to storing the digital object 15, and if the object is of insufficient interest, the digital object 15 is discarded rather than stored. One example of a local relevance determination is illustrated in FIG. 12 and is described below.

Once the priority/relevance determination is made, the digital object 15 is either stored for a greater period of time or is discarded at a block 256. If the priority determination results in the decision to store the digital object 15 and the local cache database 24 is currently fully filled with digital objects 15, a LRU procedure (e.g., module 178 of FIG. 3) may be used to discard the least recently used digital object 15 within the database 24 or the digital object for which the LRU procedure otherwise determines is the least likely to be requested in the future. Thereafter, the program 220 progresses to a block 258 which returns control to the start block 222. In one embodiment, the determination of which objects to discard is made by the caching program, which may be modified to take into account global demand statistics, as well as local usage, and a threshold value statically or dynamically set by the priority determination module 176.

If the input received by the receive input block 225 is global demand statistics from the central proxy server 12, the program 220 progresses to a block 260, where the global demand statistics are received. Subsequently, at a block 262, the local record of global demand statistics is updated. At a block 264, the local use statistics generated at block 247 are consulted and obtained. The local use statistics are compiled together with the global demand statistics at a block 266. The priority determination procedure 200 of FIG. 5 is then employed at a block 268 to calculate the local hit potential of the particular digital object 15. The hit potential is then compiled as priority data for use in block 254 (and module 166 of FIG. 3). The priority data is then stored and copies are passed on to the modules which must employ the priority data to make a priority determination at a block 272. The program 220 then proceeds to a block 274 which passes control back to the receive input block 224.

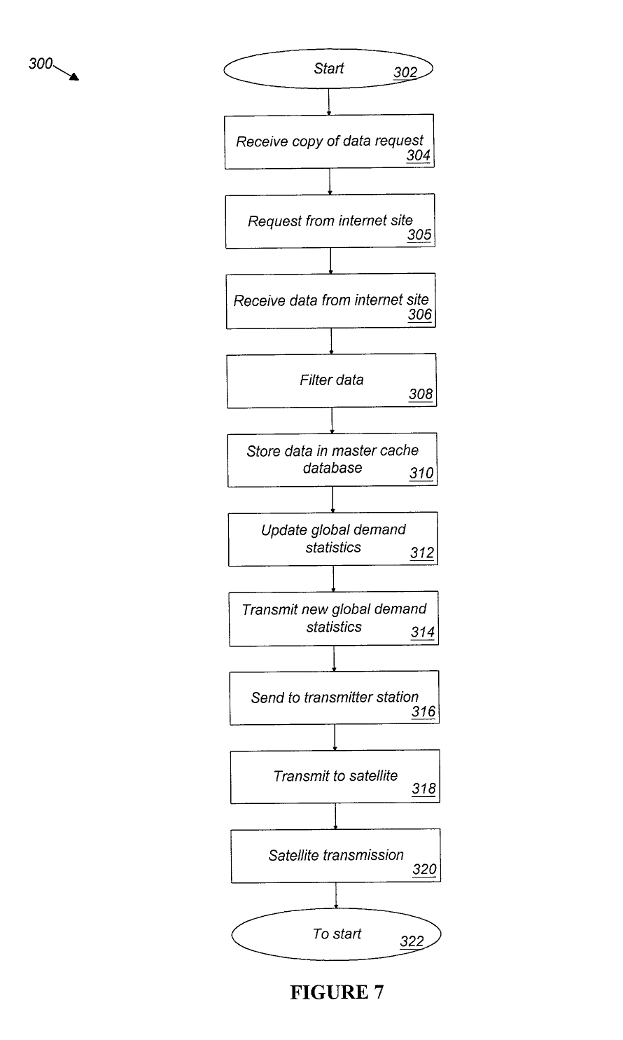

FIG. 7 is a flow chart diagram illustrating one manner of operation of a software program 300 resident within and operating on the central proxy server 12 of FIGS. 1 and 2. The program 300 initializes at a start bock 302 and proceeds to a block 304, where it awaits receipt of a request for a digital object 15. Of course, the program 300 may have other means of identifying high demand digital objects 15. Web site search engines or other pre-generated statistical data may be consulted, for instance. The central proxy server 12 may also keep a history of requests for web pages 15a, which are updated daily or weekly, etc. in order to re-transmit those pages 15a once updated.

Once a digital object 15 is requested by a local proxy server 22 or otherwise identified as being of sufficient demand to merit caching within the subscribing local proxy servers' attendant cache databases 24, the program 300 proceeds to a block 305. Here, the program 300 requests a copy of the digital object 15 from the hosting Internet site 35. Subsequently, as designated by a block 306, the digital object 15 is received over the Internet 20 from the hosting site 35. The digital object 15 may then be filtered before being transmitted and/or stored within the master cache database 312. For instance, a morality filter could be used to filter out obscene language, hate content, pornographic materials, and the like. Other types of filters may also be employed to filter by content, or filters could be used to filter out digital objects for which it is known that hit rates in the future will be low. A heuristic scheme or a request history might be employed for so doing.

At a block 310, the digital object 15 which has successfully passed through filtering is stored in the master cache database 14 as represented at a block 210. The digital object 15 is then sent to the uplink transmitter 16 as represented by a block 312. As discussed, the communication medium may be any suitable medium, but satellite transmission will be discussed herein by way of example. As shown by a block 314, the digital object 15 is then transmitted to the satellite 18. Thereafter, as shown by a block 316, the digital object 15 is transmitted by satellite transmission 34 to the subscribing local proxy servers 22. This transmission may be coordinated by the program 300.

At a subsequent block 318, global demand statistics are updated to reflect the request for the digital object 15. The updated global demand statistics may be transmitted at this point to the local proxy servers, or this information may be periodically transmitted. Subsequently, the program 300 progresses to a block 322 which returns control to the start block 302.

The system 10 of the present invention moves high demand web pages to the edge of the Internet, closer to users. The result is a much faster delivery of a majority of web pages requested by end users at a station 30, and a corresponding decrease in Internet traffic, substantially accelerating the Internet. Connection costs will correspondingly decrease, resulting in savings to users employing the system 10.

### EXAMPLE OF CENTRAL PROXY SERVER OPERATION

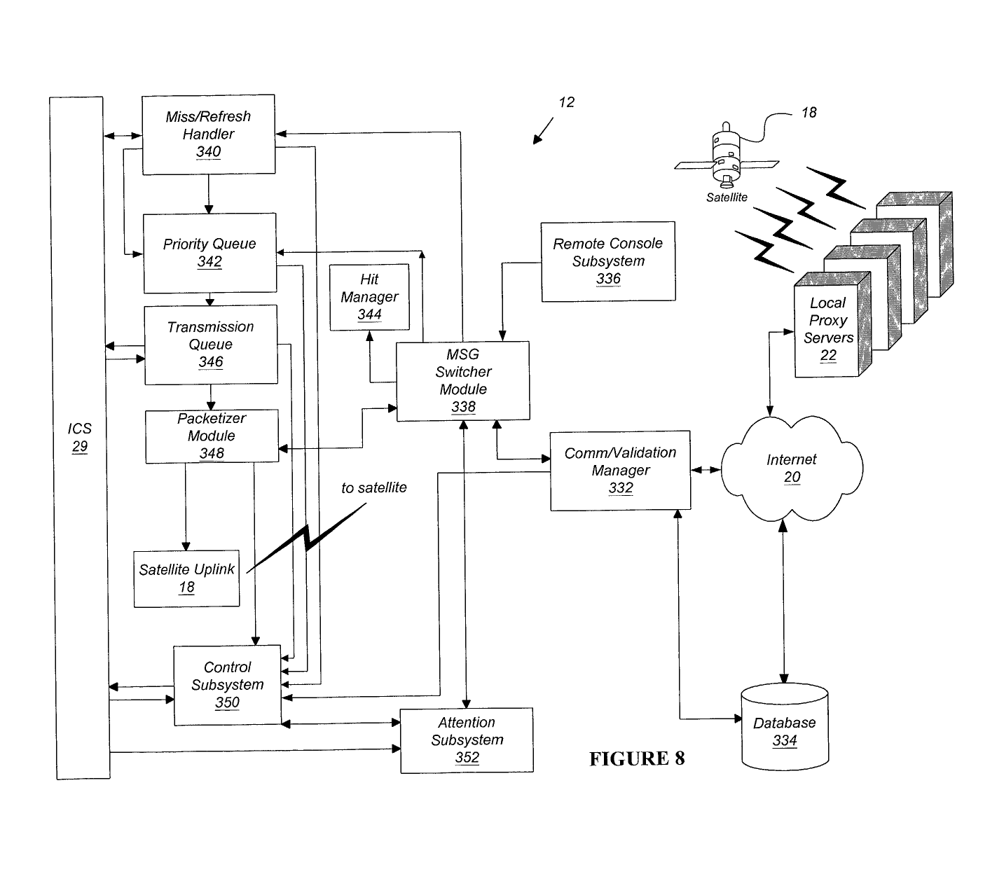

Referring to FIG. 8, shown therein is one representative example of a manner of operation of the central proxy server 12 of FIG. 1. Within FIG. 8 is shown a number of local proxy servers 22 communicating with a central proxy server 12 via a communications/validation manager 332. The communications/validation manager 332 maintains a secure connection from the central proxy server 12 to each of the local proxy servers 22 in the system. Messages from the local proxy servers 22 are communicated through the message switcher 338 to the appropriate module.

One of the primary modules for handling messages is the miss/refresh handler 340. When a local proxy server 22 is missing any requested digital object 15, a miss is then passed on to the central proxy server 12 and received by the miss handler 340. The miss handler 340 then goes out to the cache database management module 29, represented herein as an Internet Caching System (ICS), one example of which is the ICS program available from Novell Corporation of Provo, Utah, and requests the digital object associated with that miss. The cache database management module of the central proxy server will either have that digital object 15 locally in the local cache database 22 or it will go out to the Internet 20 and request that digital object 15.

When that digital object is received, all components needed to assemble that particular digital object 15 are also preferably received and assembled. The complete set of components of the digital object 15 is then stored in the database 334, and a representation of the object 15 (e.g., an object with the priority of the object as its key using C++ object oriented programming, in one embodiment) is passed on to a priority queue 342. The priority queue 342 handles all of the prioritization of various HTML pages 15a or other digital objects 15 for later transmission.

When a particular digital object 15 has a sufficiently high priority, it is placed into the transmission queue 342, which can then request all of the digital objects 15 associated with this HTML page 15a, queue them up for transmission, and send them out to the packetizer 348, where they are placed into full transmission packets and sent off to the communication medium (in one embodiment, the satellite 18). Preferably, hits for the objects 15 are still received while the object is in the transmission queue, 346, and the object's priority can still be implemented. When the object 15 is transmitted, the object is preferably placed back in the transmission queue 342 with an adjusted priority reflecting the fact that the object 15 has been recently transmitted. In one embodiment, the priority queue takes the form of a binary tree, as will be described below.

The central proxy server 12 preferably also includes a control sub-system 350 which handles all of the start-up, shutdown, initialization and processing. An attention sub-system 352 is also preferably provided and handles all user interface types of interaction. The central proxy server 12 is preferably in communication with a database 334 which may employ a schema for handling historical logging of information transmitted back from the local proxy servers 22 to the database 334 upon a message that is sent by the central proxy server 12.

The digital objects 15 which may be handled and forwarded through the system include web objects or groups of web objects that form a web page 15a. Web objects are also referred to as HTML objects or HTML data.

When a digital object 15 is placed on the priority queue, the priority of that digital object 15 is altered somewhat continuously as the central proxy server 12 receives indication from the local proxy servers 22 that one or more end users have made a cache hit on that object or that a local proxy server 22 reported another miss. This popularity information keeps accumulating even after the initial insertion into the priority queue and the highest priority digital objects 15 are considered for transmission.

The transmission queue 346 draws the highest priority digital objects 15 off the priority queue and then attempts to gather together the web objects, container objects, and their component objects and form that digital object 15 into logical messages. The input side of the transmission queue 346 receives the digital object 15. The output of the transmission queue 346 is a list or multiple lists of logical messages that represent pieces of that digital object 15.

The transmission queue 346 processes the digital object 15 and formulates logical messages, all of which are preferably small, such as about 8 Kbytes. These logical messages are placed onto an output queue, or multiple output queues, and that digital object serves as input to the packetizer module 348.

The responsibility of the packetizer module 348 is to take those logical messages, whatever size they are, and make them fit into IP multicast packets in such a way that there is no wasted space. In other words, if there are several small logical messages, they would get packed end-to-end inside of the IP multicast packets.

The maximum packet size is preferably selected to stay within the maximum data payload of an Internet frame, currently about 1500 bytes. But more importantly, the length of the data in each of the packets is preferably optimized to be approximately 1442 bytes. That number is selected in one embodiment to work with the subsequent transmission of that packet over a transmission medium such as a satellite system which incorporates DVB packets and the multi-protocol encapsulation or MPE encodings. The size is chosen to be optimal for data efficiency, so that there is no wasted bandwidth on the satellite signal. Thus, there are no fragmentary DVB (Digital Video Broadcast) packets, in one embodiment.

Once the packetizer module 348 has assembled the logical messages and filled up a packet, it forwards that packet to the satellite uplink facility 16, which in this embodiment comprises an IP encapsulator. The IP encapsulator receives packets packetized with IP encapsulation and translates them into bits and pieces that match the DVB packet sizes, which are much smaller.

In fact, each DVB packet may hold only approximately 188 bytes of data. The total size of the packet being 204. Some of the packets may be occupied by header information and error correction information. The IP encapsulator outputs those DVB packets in a transmittable state. The packets then pass through standardized hardware for radio frequency conversions and the like, as is commercially available and well known.

The packets are then sent from the transmission dish up to geo-synchronous orbit, to the satellite, where they are redirected back down to be received by each of the subscribing local proxy servers 22. Preferably, a satellite receiver at each site receives and recombines the DVB packets into the original IP multicast packets that were fed into the IP encapsulator at the uplink facility.

The IP multicast is a standard protocol known in the industry. The packet structure of IP multicast is generally the same as that of IP packets used with TCP/IP or UDB/IP transport protocols. A primary difference, however, is the addressing of where the packet going. That is, the target addressing uses special range IP addresses which indicate that the packets can be received by many receiving stations at the same time.

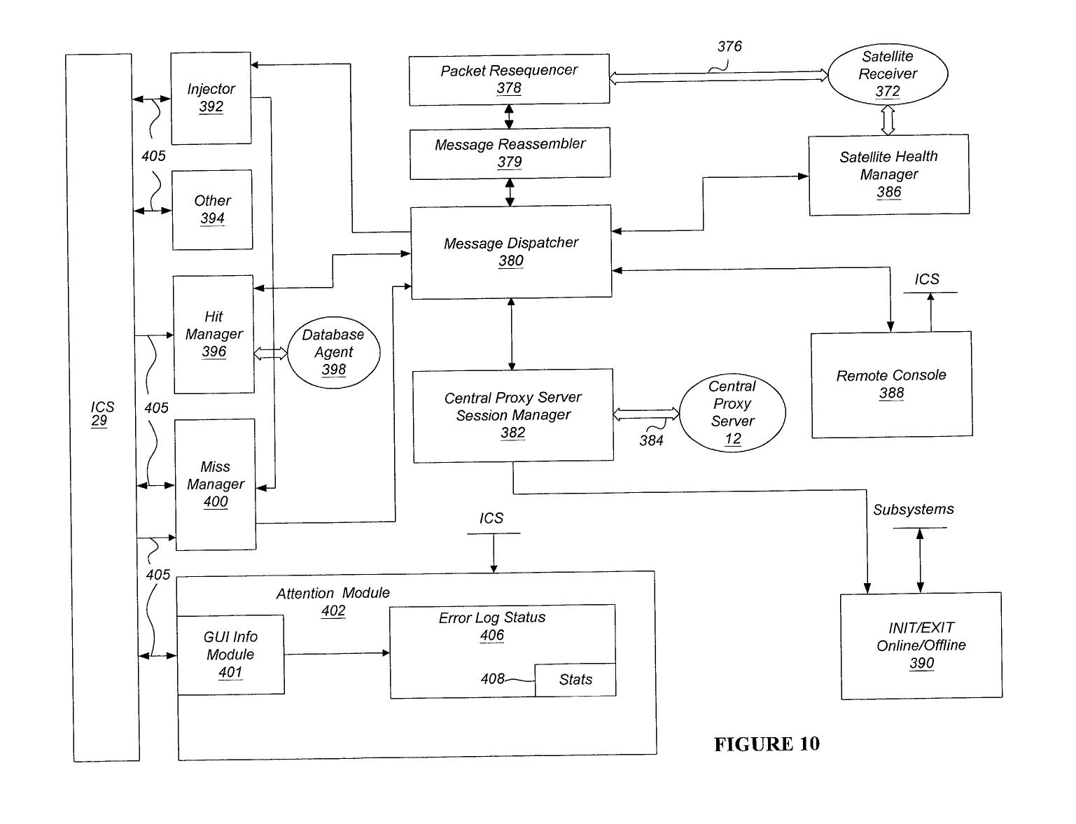

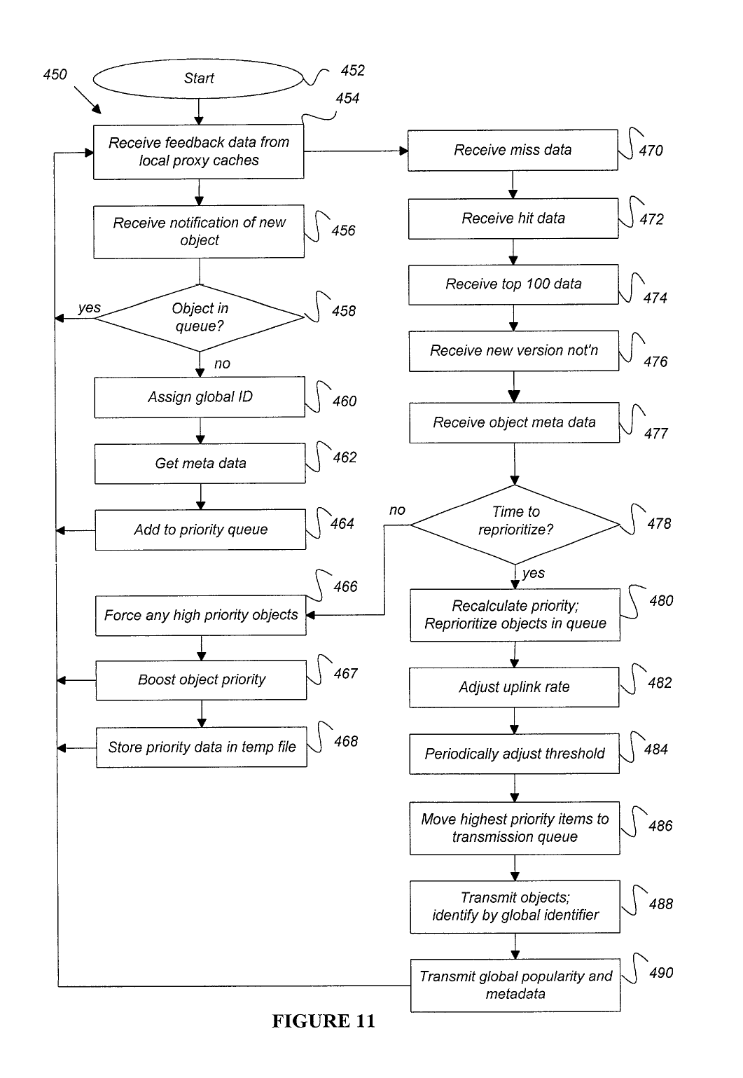

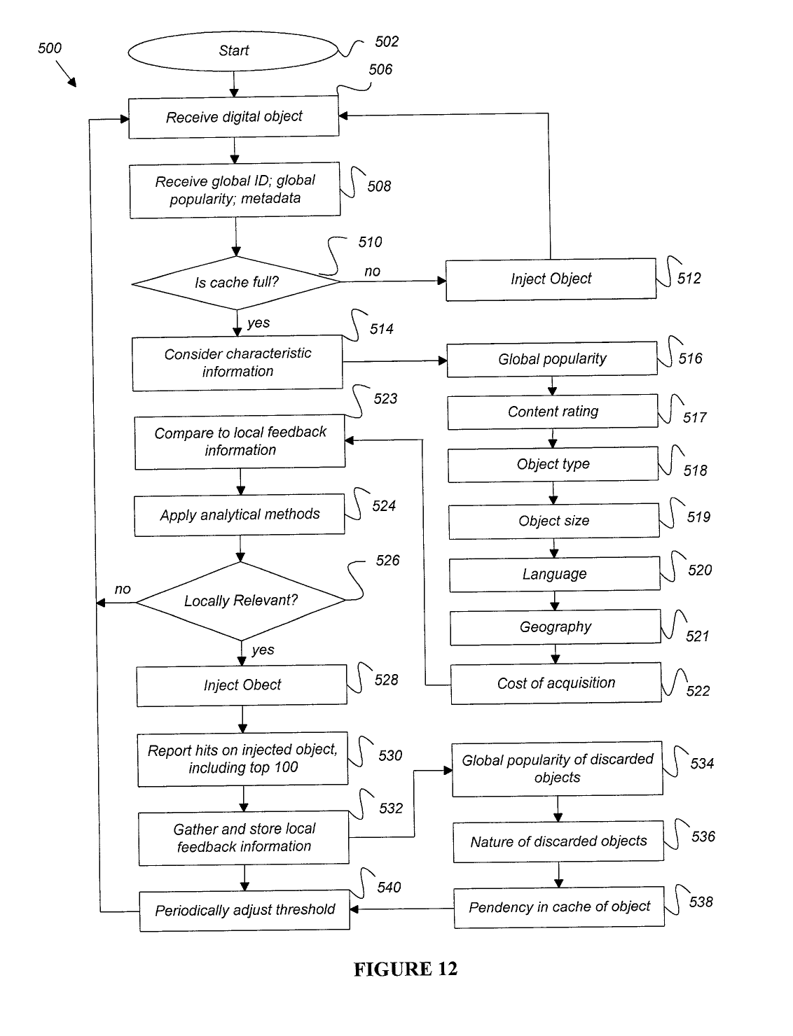

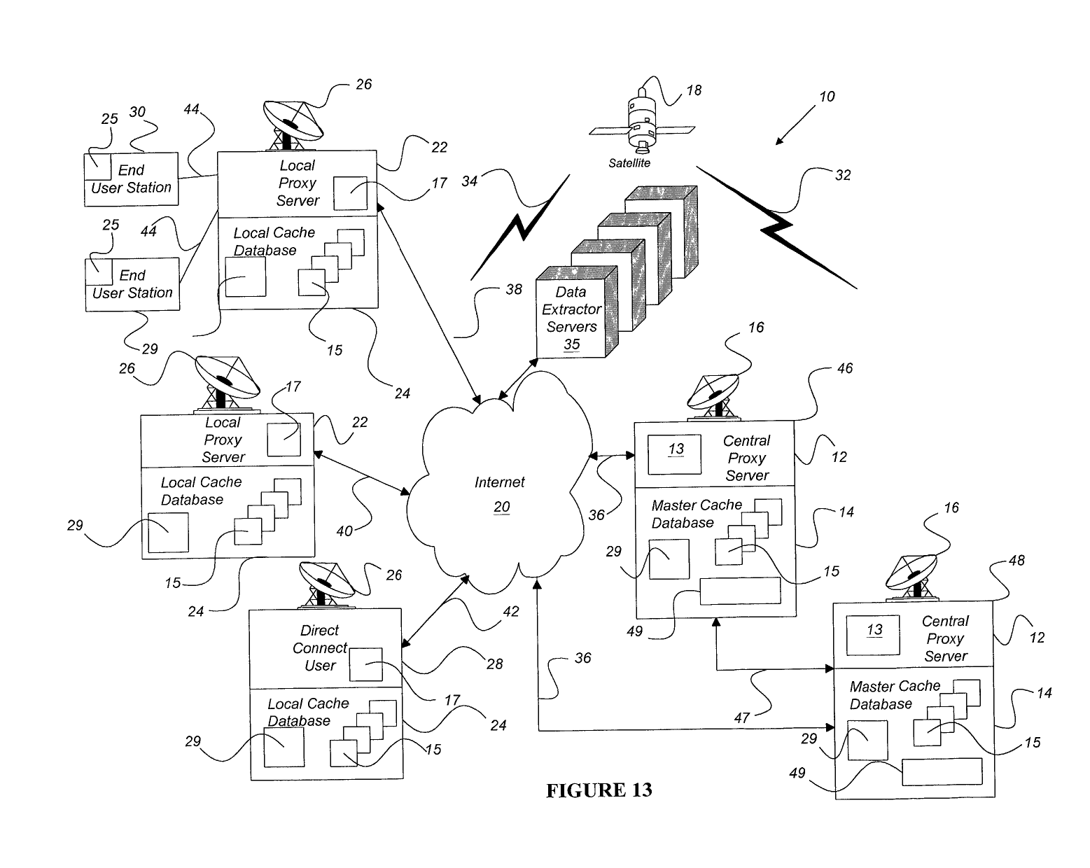

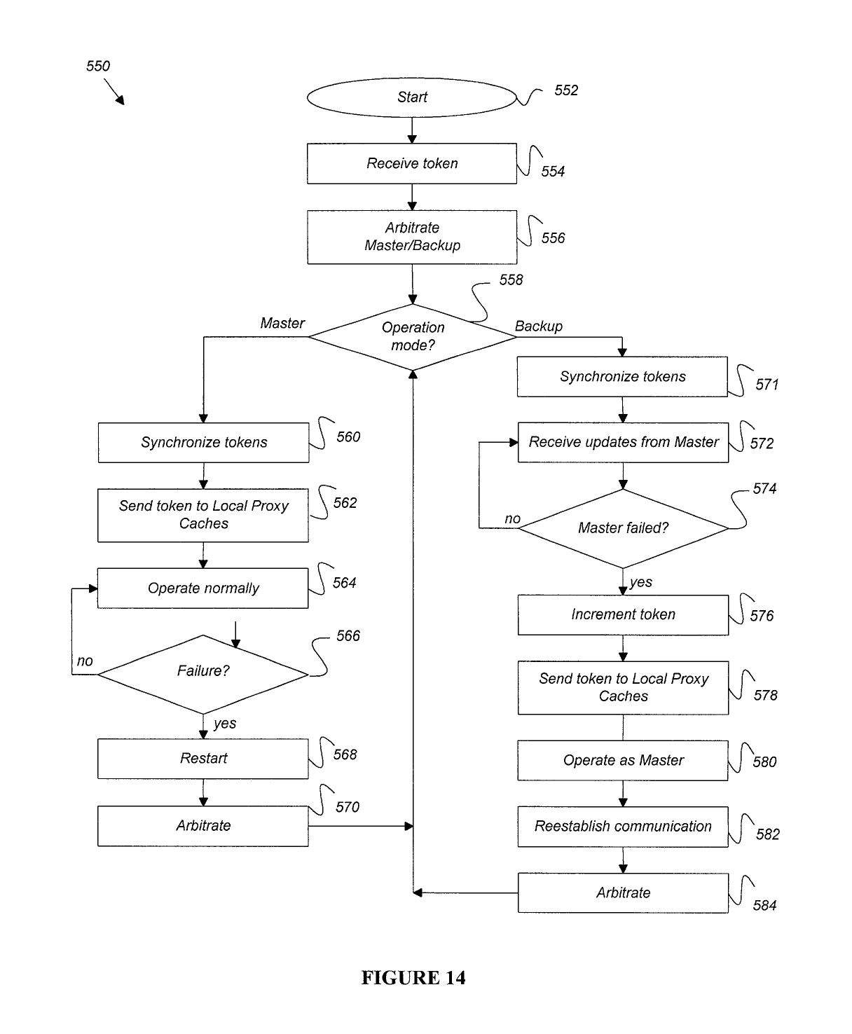

Under this embodiment, a one to many transmission originates at the central proxy server and is delivered to the local proxy servers 22. The satellite receiver or other transmission medium receiver reconstructs and outputs the original IP multicast packet onto a local Ethernet network, which is preferably a private network, and which may be a single cable between the satellite receiver and the user net in the local proxy cache machine. The local caching module 17 receives a payload from those packets which is processed as illustrated in FIG. 10.

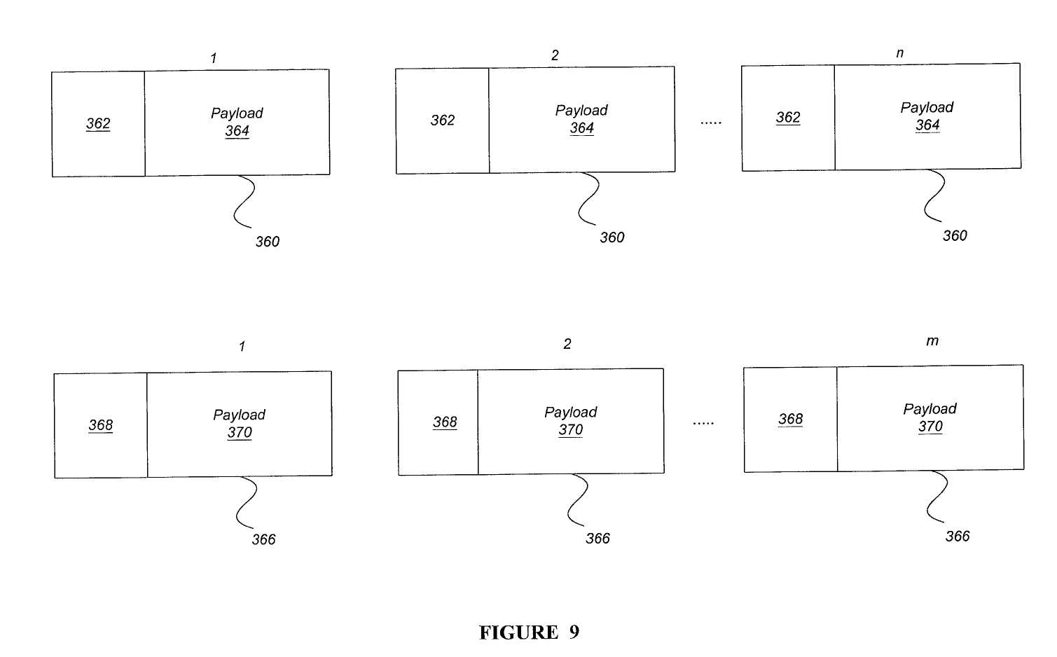

Referring now to FIG. 9, shown therein is a block diagram illustrating one embodiment of the configuration of a series of packets constructed in the transmission of a digital object 15. Initially shown is the transformation of the web objects 15 that are received out of the transmission queue 346 of FIG. 8 and inserted into individual object messages 360.

Each digital object 15 is preferably broken up into multiple object messages 360 ranging from 1 to N. Each object message 360 consists of an object message header 362 and a payload 364. Each object message 360 is preferably broken up into a satellite packet 366 by the packetizer module 348. The Satellite packets, as previously stated, are preferably 1442 bytes in size, but may be any suitable size selected to provide optimal satellite throughput.

The satellite packet similarly consists of a packet header 368 and a payload 370. There are 1 to M packets for every given object message. The satellite packets are converted into IP multicast format via industry standard operations. The IP multicast format is then converted into a digital video broadcast (DVB) stream, which is once again an industry standard.

The DVB packets can be constructed using a hardware and software solution. An example of this is a DVB packetizer product which is provided by Skystream International of Sunnyvale, California. On the receive side, the DVB packets are received by a satellite modem, which then rebuilds those packets into IP multicast format. The thusly formatted packets are then received by the local proxy server 22, reassembled, and eventually the entire web object 15 is reconstructed using the inverse of the process previously described.

### EXAMPLE OF PRIORITY CALCULATION BY THE CENTRAL PROXY SERVER

FIG. 11 illustrates one method 450 in which the central proxy server 12 of FIG. 8 may utilize feedback from local proxy servers 22 to make a global priority calculation for digital objects 15 stored therein. In one embodiment, the central proxy server 12 is configured as described for FIG. 8. The method 450 begins at a step 452 and progresses to a step 454 where the central proxy server 12 receives feedback data from the local proxy servers 22. The feedback data is received periodically over a network, typically the Internet 20. Various forms of local feedback that may be transmitted are shown in steps 470-477 and will be discussed below.

As indicated at a step 456, the feedback data may indicate a new digital object 15 which is not currently in the priority queue 342. If such an object 15 is indicated by the feedback data as shown by a step 458, the object is placed in the priority queue 342. In the depicted embodiment, this comprises assigning the object 15 a global identification number as indicated at a step 460, requesting the content rating and other meta-data for the object 15 from the communicating data extractor servers 35 as indicated at a step 462. The object 15 is then added to the priority queue 464, in order of its initial priority. This initial priority is preferably a default value. The priority values within the priority queue 342 may be numbers, for instance, between 0 to 255, or more preferably with a higher resolution, such as −32000 to 32000. A value of 10, for instance, may be assigned a new object 15. As discussed, those objects remain in the priority queue until they drop to a sufficiently low value as to be deleted, or reach a sufficiently high value to be passed to the transmission queue. Once an object has been transmitted, it may be placed back in the priority queue 342, but its priority may be decremented to reflect its recent transmission.

Returning to step 454, the feedback data may be received at various times, and may include miss data received as indicated at a step 470, hit data received as indicated at step 472, “top 100” data received as indicated at a step 474, and notification of new versions of transmitted objects received as indicated by a step 476. The hit data may include hit data for objects requested locally by users of the local proxy servers 22, but not yet transmitted by the central proxy server 12, as will be discussed below. In addition, data from external sources such as the data extractor servers 35 may be received as indicated by a step 477. The external sources may be commercially available sites, and may also be servers configured to crawl the web, locating meta-data for objects 15, as well as determining popularity or other information about the digital objects 15.

In one simple embodiment, such data is immediately used to recalculate priority of the objects 15 in the priority queue, and the objects 15 are then reprioritized. Nevertheless, in order to avoid content churning, as described in the captioned examples below, such updates may occur only periodically, either at intervals of time, or upon changes of priority of one or more objects of a selected incremental amount. Thus, in the depicted embodiment, the method 450 checks at a step 478 to determine whether it is time to reprioritize yet. That is, has the selected amount of time lapsed, or has the priority of the selected objects changes sufficiently? If not, the feedback data is stored in temporary files to be used in recalculating object global priority once it becomes time to reprioritize. In one embodiment, however, some feedback data is of such high priority, that it is recalculated immediately. Such feedback comprises, in one example, notification from a local cache advisor that an object transmitted from the central proxy server is out of date and that there is a newer version.

Such feedback may be gained, for instance, when a local caching module 17 attempts to inject an object into the caching database 24, and the object is rejected because the cache management software 29 (of FIG. 8) rejects the object because it already has or is otherwise aware of a newer version and informs the caching module 17 of this fact using the API interface 405. The local proxy server 22 then transmits notification of the newer version to the master proxy server 12, preferably immediately and over the Internet 20.

Thus, as indicated at a step 466, such high priority objects are immediately made the subject of a reprioritization, or in a further embodiment, are immediately moved into the transmission queue 342 for uplink to the satellite 18. In addition, a priority boost may be given to the object as indicated at a step 467. In one embodiment the priority boost is sufficient to achieve immediate injection of the object into the transmission queue 342 is given to the high priority objects.

If, on the other hand, it is determined at the step 478 that it is time to reprioritize, the method 450 progresses to a step 480. At the step 480, the recently transmitted feedback data, as well as any such data stored previously in temporary files as discussed is compiled and the priority of all affected objects 15 is recalculated. The objects 15 are then reprioritized in the queue. Typically, the objects are stored in the master cache database 14, and only a short identifier such as a tag is stored in the priority queue, as will be discussed below. The tag is linked by pointers to other data regarding the object 15 in the master cache database 14. It is that identifier tag that is manipulated in the priority queue 342 to represent the newly calculated global priority.

After the objects are reprioritized, other house keeping items may also be conducted. As indicated in FIG. 11, one such item is to check the satellite transmission rate and to periodically adjust the uplink rate to the satellite accordingly. The new uplink rate may be used to adjust the threshold at which objects 15 are moved from the priority queue 342 into the transmission queue 346, as indicated at a step 484.

As indicated at a step 486, the highest priority items, typically those meeting the threshold level set at the step 484, are periodically transmitted to the transmission queue for transmission to the satellite 18. Those objects are uplinked to the satellite as indicated at a step 488. Transmitted with the objects are the global identifier for each object 15, as well as the global popularity for the object 15, and optionally, any meta-data for the object, as indicated by a step 490. Control is then returned to the step 454, and the method 450 continually loops in this manner until the central proxy server 12 is shut down.

### EXAMPLE OF LOCAL PROXY SERVER OPERATION

Referring now to FIG. 10, shown therein is a block diagram illustrating the operation of one embodiment of a local caching module 17 operating within a local proxy server 22 of FIG. 1. Within FIG. 10 is shown a satellite receiver 372. Emanating from the satellite receiver 372 are transmission signals 374 and 376 indicating network transmissions using multicast packets for digital objects 15. The digital objects 15 are shown being received by a receive assembler module 378.

Each depicted module represents a software subsystem or component of the local caching module 17. A packet resequencer 378 receives the IP multicast packets as they are transmitted and resenquences the packets in the proper order if needed. The properly sequenced packets are then passed to the message reassembler 379 which extracts the contents of the packets and assembles them into messages and/or digital objects 15.

The digital objects 15 are then transmitted via a message dispatcher 380, which is basically a switching mechanism, to an injector module 392. The injector module 392 accumulates the object messages, one or more object messages per digital object, reassembles those messages into the web object, and injects that digital object 15 into the local cache database management module 29.

The injector module 392 preferably does not wait until all of the object messages for a digital object 15 have been received. As long as they are coming in order and it has the very first message, it proceeds to create that object 15 as far as the cache database management module is concerned and will continue to append each additional object message as it arrives, until the last object message has arrived. If anything is out of order, it waits until it receives the missing portions.

A satellite health manager 386 queries the satellite receiver 372 about every fifteen seconds sending SNMP (Simple Network Management Protocol) queries by using the UDP/IP transport and the satellite receiver, if all is well, responds affirmatively.

If that is not the case, satellite health manager 386 sends a message via the message dispatcher 380 to a central proxy server session manager 382. The session manager communicates with the central proxy server 12 over a TCP/IP connection 384. That connection is preferably maintained over the standard Internet and the report of satellite receiver misbehavior can thus reach the central caching module 13 and trigger an alarm or notification such that operations personnel can try to identify the problem and resolve it.

The satellite health manager 386 is configured to simultaneously log an error in the systems error log on the local caching module 17. An attention module 402 is also preferably provided. Within the attention module 402 is shown a GUI information module 404, an error log status module 406, and a statistics module 408. The attention subsystem 402 is responsible for bringing attention of events to human users by displaying information through the graphical user interface to the customer or to any remote administrator that is hooked into the cache database management module and is accessing the specific management panels. The attention module 402 also logs those errors in a local file.

A remote console 388 is shown provided for diagnostic purposes. The present invention allows a remote connection over the regular Internet to the local caching module 17 with a simple utility which implements what appears to be just a simple command line such as a DOS command line. The system may enter commands of its own through the local caching module 17 that give back responses providing information about internal statistics and performance and other diagnostic information. Those commands may also be used to set or change internal parameters or characteristics of the local caching module 17 for purposes of optimizing its performance.

An init/exit module 390 is also shown and is preferably configured to coordinated initialization the various subsystems of FIG. 10 with the local cache management module 29 when the system is brought on-line. The init/exit module 390 also provides such coordination when the system is taken off-line.

As an example of a manner of use of the local caching module 17, a user with a client browser 25 may be browsing the Internet through a local cache database management module. If the user requests a web object 15 which has not been previously cached by the local cache database management module, the local cache database management module calls up the miss manager subsystem 400, identifies the URL (universal resource locator) of that web object on the Internet, and gives the local caching module 17 an opportunity to take steps to find and gather that digital object and deliver it to the local cache database management module 29 by means of the present system in the manner which has been described up to this point, where the digital object is received over the satellite by the local caching module 17 from the Central proxy server and injected or discarded back into the local cache database management module. Thus, the local cache database management module is given first right of refusal and tries to satisfy the end user request for a particular web option.

### EXAMPLE OF HIT AND MISS RATE REPORTING

Referring to FIG. 10, the local cache database management module 29 is preferably configured to report cache misses to the miss manager 400 of the local caching module 17. In response, the miss manager 400 preferably transmits a message immediately to the central proxy server 12 via the message dispatcher 380 and the central proxy server session manager 382 to instruct the central proxy server 12 that the local proxy server 22 does not contain a copy of the web object 15 the end user is seeking.

The central proxy server 12 preferably uses the miss information in calculating global miss rate information. That is, the central proxy server 12 uses the miss reports that it receives from the local proxy servers 22 in the overall system 10 to compute the relative priority of web objects 15 in the priority queue 342.

Referring back to the local caching module 17 of FIG. 10, also provided therein in the depicted embodiment is a hit manager 396. The hit manager 396 is similar to the miss manager 400 in that when a client requests a web object 15 from a local cache database management module 29 and the cache database management module 29 has that object already stored in its cache, a hit is registered. The local proxy server 17 accumulates hit counts on an object-by-object basis as they are reported. It then reports that information at least every few seconds to the central proxy server 12 via the message dispatcher 380 and the central proxy server session manager 382.

The local caching module 17 preferably logs hit reports under several different circumstances. Initially, it may only have room to track hits on a certain number of objects at once, which in turn determines the size of the report messages that sends to the central proxy server 12. Once a message content becomes full, it sends the message, allowing it to empty or zero out all of those accumulating buffers, counters, and accumulators.

Each web object that the system 10 delivers is preferably assigned a globally unique identifier, and the hit count report utilizes that identifier to be very efficient in forwarding hits to the central proxy server 12. In so doing, it may simply send out an array of structures. In one embodiment, each structure is an array comprised of two elements. One element is the global identification number which represents the web object that the system is tracking. The other element is a count of the number of hits that has just been recorded with a very recent task.

As that array of structures fills up or is used up by recording hits for different objects, the current message is sent as soon as all of the array structures are in use or, if not all of them are in use, the partial messages are preferably transmitted no greater than about five seconds apart to make sure that information stays timely until it gets back to the central proxy server 12. That array of information or partial array is also transmitted immediately if one or more of the objects which are being hit has experienced a very large number of hits in a very short period of time. A hit frequency measurement is preferably observed, as well as just accumulations of numbers of total hits.

All of these messages that are sent between the central caching module 13 and the local caching module 17, whether they are sent over the traditional Internet using TCP/IP connections or whether they are delivered via multicast transmission, share one common protocol structure or proprietary protocol means. That is, at the beginning of the message, is a header that identifies the overall length of the message and the target of the message.

For example, when a miss manager of a local caching module 17 needs to send a miss report, it prepares a message, and a header is appended that will identifies the target as e.g., “central proxy server subsystem miss handler.” When the central proxy server 12 transmits object messages, the header of those messages targets the local caching module injector subsystem and it is the responsibility of the message dispatcher box to switch those messages back and forth between the appropriate subsystems on the local or master.

The present invention thus reports hits that have been registered globally on objects that are being tracked by the system 10 and attempts to report those hit counts as quickly and efficiently as possible while they have relevance. When the hit report reaches the central proxy server 12, the hit counts are matched up with the appropriate web object that is being tracked using the global identification number. The hit counts are then added into the prior known hit counts for that object and a new priority for that object can be calculated using miscounts and hit counts to date, as well as optionally, other selected priority and popularity information.

Every time a hit or miss report is received by the central proxy server 12, it accumulates that information and updates the priority totals. Nevertheless, it may not actually transmit, or complete the recalculation of the priority, because doing so requires removing the object from the priority queue and reinserting them at a new position. Given that there will likely be hundreds of thousands of web objects represented from the priority queue at any given time, doing so becomes an expensive proposition in terms of computer processing time. Rather, the potential change in priority is evaluated, and when it crosses a certain threshold or every so many times a report has been received, the object is reinserted into its appropriate position.

Relative priorities of objects 15 are preferably transmitted under two circumstances. First, when the object itself is transmitted, the global priority for that object is transmitted with it. That information is provided to the local caching module 17 and to the local cache database management module. The local cache database management module at that point preferably incorporates the global popularity data that has been provided into its own internal priority calculations to determine whether it wants to keep the object its local cache on a long-term basis.

The second time that an object's priority is typically transmitted is when the global priority for the object has changed substantially that is, beyond a selected threshold. Since the object data itself has not changed, there is no need to resend the object data, but it is useful to send the very brief, very small administrator message saying the object as identified by its global identification number and has a new global priority for local consideration.

In addition to recording global hit counts on a moment to moment basis for various objects, the hit manager preferably also keeps the longer term totals of those hits. In fact, it preferably keeps a total for a time period of, for example, fifteen minutes. Every object that has had any hits on it during that time period is then evaluated relative to all the other objects in the priority queue. The objects are sorted out and the record of the ordered top 100, 200 or some other selected number of objects are logged to a file in the local cache box and that file is made available for subsequent retrieval by the central caching module 13 and a historical database agent 398.

The historical database engine 398 periodically queries each of the local caching modules 17, to receive all of the accumulated 15 minute logs and data regarding what was most popular in the local caches during that 15 minute time period. This information is used to update all the different local caching modules 17 and also presents a number of opportunities for data mining. For example, the collective “top 100” lists of the associated local proxy servers 22 may be combined into a highly accurate list of what is popular on the Internet and commercially marketed or used in research.

One advantage of the system 10 of the present invention is that there preferably exists a closely integrated relationship between the local caching module 17 and the cache database management module 29. This allows the system 10 to communicate information such as hit reports, that are not available in prior art caching systems. Popularity information may be gathered for a digital object 15 even after the object has been injected into a local cache and the popularity of any given object can be monitored continuously.

Another advantage is that hit counts are accumulated within hit reports at the local cache. Many hit counts may be accumulated before transmission due to time constraints. Thus, a large number of hits on a selected object may be transmitted in a single report.

### EXAMPLE OF TIGHTLY INTEGRATED CACHING SOFTWARE

Referring to FIG. 10, a number of arrows 405 are shown directed into and out of a cache database management module 29. These arrows in essence represent the functional interface for an application programming interface (API). In one embodiment, the tight integration between the cache database management module 29 (one example of which is an ICS program, as discussed) and the local caching module 17 is conducted through the use of an API. The term “API” as understood in the industry is a collection of programming interfaces that allow one set of software to access services or information directly from another set of software in a standardized manner which separates and protects each side from the other, through an established method of communication. Typically, the two software modules operate on a common server, and their communications are transmitted directly between each other.

The API can be considered to be a type of dynamic binding between two applications operating on a common server or other processor. The terms “integral communication,” “integrally communicate” and “tight interface” represent some sort of binding between two separate applications on a common processor. As disclosed, the binding is preferably a dynamic binding, one example of which is conducted through an API.

An API defines all of the interface information that must be implemented by a vendor in a product. The use of an API-type interface in one embodiment allows the present invention to benefit from close, substantially instantaneous communication between the local caching module 17 and the cache database management module 29. For example, referring to the injector module 392 of FIG. 10, arrows pass from the injector module 393 into and out of the cache database management module 29. In one embodiment, four functions are provided which the injector may call on which occur within the cache database management module 29. Each of those functions is called with a short command, and if necessary, accompanying parameters. Those commands are responded to by the performance of the requested function, which may, for instance, include the depositing of data in a selected buffer or memory location.

As an additional example, when the injector module 392 receives web objects or other files 15 and needs to transmit those objects to the cache database management module 29, it uses commands from selected API instruction sets and passes those commands to the cache database management module 29 to achieve that desired function.

Other API functions may include an instruction or command which requests the cache database management module 29 to locate an object 15 within the local cache database 24. Another API instruction may notify the cache database management module 29 that a particular digital object 15 is being sent and is to be saved together with another stored digital object 15. This digital object may not actually be part of the original digital object 15, but may be related information, such as a component of a web page 15a.

In one embodiment, the cache database management module 29 may respond to the instruction asynchronously, that is, at varying times. The responses may be immediate, or may be delayed, to acknowledge the results of an initial request, for instance. Other functions may comprise cache database management module one-way communication to the local caching module 17 to provide notification of certain events such as a hit report or a miss report.

Thus, under the invention, an API interface is very highly integrated between the local caching module 17 and the cache database management module 29. This provides the advantages of being able to communicate internally with the cache database management module 29 and being able to receive unique types of information back from the cache database management module, including, for instance, statistics such as hit reports, almost instantaneously.

Integration does require some additional support and alteration by the vendor and produces the results of greater flexibility of cache management and information extraction. Additionally, speed is increased, so that reported information is more current. In prior art arrangements, where an software applications residing with different external servers communicate, there are necessarily slowdowns resulting from network transmission delays, processing of network messages in and out of the boxes, and from hardware bottlenecks. These include the use of drivers of the hardware and slow funneling of information that must work its way up through the various hardware protocols and then back down again. These slowdowns are avoided through the tight integration of the present invention. Under the invention, communication to the cache database management module 29 may be as simple as making and responding to a function call.

Prior art caching systems typically receive new objects in the order the objects are sent to that caching system. The caching system then just throws out the least recently used digital object to make way for the new digital object coming in a very unintelligent manner. Prior art systems may provide limited feedback on misses, due to the need to request a digital object that is not present in the cache. In such systems, there is no sense of global priority. That is, each remote caching system is unaware of what is popular elsewhere, other than a possibly a rudimentary calculation based upon misses. The prior art caching box responds to transmitted digital objects by making room for this new arrival, and uses it's own best judgement in doing so.

Thus, one embodiment of the present invention is based directly on having an integrated API relationship between the cache advisor and the cache software. This allows the system 10 to have access in real time to prepare information about what is going on inside the cache database management module 29, and also what is going on relative to particular web objects 15 that are being tracked. Given that information, the local caching module 17 and the central proxy server 12 collaborate. Each of the local caching modules 17, that are online and subscribed to the system 10 report their popularity information to the central caching module 13, which compiles that information and sends it out together with the rated extracted digital objects 15. The local caching modules 17 then utilize that global popularity data in determining which digital objects 15 to keep and which to discard, optionally in combination with unique local determination factors.

Local proxy servers 22 thus act as the eyes and ears across the world. Due to the ability to communicate closely with the cache database management module, the local proxy servers 22 are able to extract at least hits, and optionally, many other types of information from the local cache databases 24. Examples of information that may be extracted from the local caching module 17 under the present invention include acquisition time—the time that it takes to receive an object over the Internet; information such as what is being deleted out of the local cache, which may indicate local priorities; time data—digital objects that are hot in a particular area or time zone; hit time—the time it took the local cache database management module to retrieve a digital object from the Internet; and other particularized information about what digital objects are being kept or thrown out of the local caches. Even the time zone of where that local cache is can be related and associated with the global popularity data.

### EXAMPLE OF LOCALIZED RELEVANCE DETERMINATION

FIG. 12 illustrates one embodiment of a method 500 for calculating the local relevance of objects 15 transmitted from the central proxy server 12 and for determining whether to attempt to inject transmitted objects 15 into the local cache database 24. The local relevance determination of FIG. 12 allows each local proxy server 22 to make an individualized assessment of transmitted objects 15 for use in deciding whether to store or continue to store the objects in the attendant local caches 24. The local relevance determination method 500 may be conducted by the local proxy server 22 illustrated and described with respect to FIG. 10, and particularly, by the local caching module 17 of the local proxy server 22.

The method 500 starts at a step 502 and progresses to a step 506 where digital objects 15 are periodically received across the transmission medium from the central proxy server 12. Generally, the objects 15 are multicast, and may be transmitted by satellite transmission, as discussed above. Preferably, the server on which the local proxy server 22 operates is capable of multitasking, and consequently, the steps of the method 500 may be happening in parallel, rather than in the illustrated sequence, which is given by way of example for discussion purposes only.

When a digital object 15 is received, its global identification number assigned by the central proxy server 12 is also received in the illustrated embodiment, as may be the global popularity calculated for the object 15, and any meta-data that may have been collected for the object 15. Preferably, this data is transmitted together with the object 15, but of course, it could also be transmitted separately. In fact, once an object has been transmitted, the central proxy server 12 continues to update its global popularity for use by the local proxy servers 22, and those updated global popularity figures are periodically transmitted in a continuous manner.

The object 15 is received into the packet resenquencer 378 of FIG. 10. The object is resequenced and reassembled, as described above. The local cache advisor software 17 must also decide whether to attempt to inject the object 15 into the local cache database 24. As indicated by a decision step 510, if the cache is not full, typically because it has only recently been brought online, the object 15 is immediately injected as indicated at a step 512. If the local cache 24 is operating at capacity, and injecting the object 15 would displace other cached objects 15, it must be determined if the object 15 would be sufficiently popular locally to do so.

In making this local relevance determination, the transmitted global popularity rating and all meta-data are preferably considered. Of course, the local caching module 17 could utilize only selected meta-data, or could omit the global popularity rating from the calculation. Such considerations are indicated by way of example by steps 516-522. For example, global popularity may be considered as indicated at a step 516. Additionally, other quantitative data, referred to collectively herein as “meta-data” may also be considered. For instance, the content rating as provided by the servers 35 of FIG. 1, or other sources, may be considered at a step 517, the object type, such as HTML, MP3, streaming video, JPEG, GIF, etc., may be considered at a step 518. The size of the object may be considered at a step 519, the language that the object is primarily written in may be considered, as indicated by a step 520, and the geography or origination of the object 15 may be considered at a step 521.

In addition, as indicated in a step 522, the cost of origination of the object 15 may also be transmitted for consideration in making the local relevance determination. In one embodiment, the cost of acquisition includes the time it took the central proxy server 12 to acquire the object. Size of the object may also be considered, as well as, in one embodiment, how frequently the object is refreshed. For example, a web page available from a low latency server that is small in size would have a low cost of acquisition, while a web page that is large in size and has a high latency would typically have a high cost of acquisition, making caching of the object 15 more desirable.

This data is then compared to local feedback information at a step 523. For instance, in the depicted embodiment, at subsequently described steps 534-538, data is gathered for each object 15 discarded from the local cache database 24. Such data may include the meta-data for that object when discarded, including the objects described at the steps 516-522, and additionally, the time of pendency of the object in the cache may also be considered. This data is analyzed and quantified, and used to determine the likelihood of an object 15 remaining in the cache. Local hits and misses on objects of different types may also be compiled, as discussed above.

This actual relevance calculation is made at a step 524. In one embodiment, by way of example, the calculation of step 524 involves the use of analytical methods such as fuzzy logic, including statistical methods or other logical comparative or analytical techniques. For example, various qualities of an object as indicated by its global popularity and meta-data are each considered as a separate dimension. Each dimension is quantified against the history of treatment (e.g., time of pendency of objects of that type before being discarded, proportion of hits on objects of that type, and/or percentage of objects of that type being quickly discarded) of similar objects with that quality, and each dimension is given a rating according to how popular it is to local users of the cache 24. The comparison may be quantitative as well as qualitative, comparing numerical values such as hits and misses and global popularity, as well as taking into account characteristics and local interest in the language of the object, origin of the object, and the like.

The various dimensions are then each considered, possibly using analytical tools, in a simple example, by adding the dimensions together, with optional weighting between the various dimensions. Each of the various dimensions, or the cumulative sum of the dimensions may be compared to a threshold value or values. The comparison to the threshold value(s) is indicated at a decision step 526. If the relevance calculation of the object 15 does not meet or exceed the threshold value(s), the object 15 is not injected, and control is returned back to step 504.

If, however, the threshold value is met, the object is injected or attempted to be injected into the local cache 24 at a step 528. The injection may be merely attempted, because the local cache 24 may operate under a cache management system 29 that uses its own relevance determination algorithm. If the object does not meet the requirements of the local cache, it may not be accepted. Additionally, the local cache may have various filters therein which may cause the object 15 to be rejected from being cached therein. The cache management system 29 typically displaces one or more objects 15 upon receiving the new object 15, as has been discussed. The cache management system 29 may use a commercial LRU algorithm for so doing, or may employ a relevancy algorithm similar to that discussed, and may similarly employ the transmitted meta-data or other information compiled by the local caching module 17.

If the object 15 is injected, requests for the object are still reported, but are reported as hits, rather than misses. Reporting hits is indicated at a step 530. The hits may be reported together with misses, and in the same manner described above. Hits are preferably collected and compiled locally, and are also transmitted to the central proxy server 12, as discussed. Hits for objects transmitted from the central proxy server 12 are preferably compiled and transmitted, as are in one embodiment, hits on objects filled locally and not transmitted from the central proxy server 12. These hit reports may also be used by the central proxy server 12 in making a global popularity rating for an object 12 that has not yet been transmitted.

In the continued operation of the local proxy cache 22, the aforementioned local information is gathered and stored as indicated at a step 532. This may include compiling statistics about discarded objects as illustrated in steps 534-538. For instance, the global popularity of discarded objects may be gathered and compiled at a step 534, the nature of discarded objects may be compiled, at a step 536, and the pendency in the cache of the discarded objects and/or other meta-data measurements may be gathered at a step 538. This data may then be cross-correlated, for instance, to determine the average pendency of objects of a certain language, content type, subject matter, and/or global popularity. This information is then used in making the analysis of step 524 and the decision of step 526.

As indicated at a step 540, the threshold value used at the step 526 may be periodically updated. In one example, if objects are being injected too quickly and objects having a higher local demand are being displaced by those objects, the threshold value is increased. If on the other hand, discarded objects have a significantly lower local priority than objects being injected, the threshold value is decreased. The method 502 continually loops, preferably with parallel processing of the various steps, until shut down of the local proxy server 22, at which time it terminates.

### EXAMPLE OF TRANSMISSION OF WEB PAGES IN THEIR ENTIRETY

The system 10 of the present invention allows a web page 15a or other digital object 15 to be transmitted in its entirety, rather than having to transmit a listing of the contents of the web page 15a and then going back and separately requesting those contents as is conducted in prior art Internet accesses. One feature preferably provided within the cache database management module 29 of the present invention is the ability to examine an HTML web object (such as a web page) 15 and determine its component parts. The HTML object may be a container that describes the complete layout of a particular page 15a that will be seen on the browser window 25 of a user station 30. The container or other such directories typically contain most of the readable text and contain specific instructions, using the hypertext mark up language syntax, to identify other web objects, images, Java applets, or other types of web object that are part of the page.

Upon receiving a user request for a digital object 15, the cache database management module 29 preferably looks at the container for the objects 15. The container typically refers to all of the other images and elements that comprise the total Web page experience. The cache database management module 29, upon receiving the HTML object 15, scans through it immediately, parsing out the particular references to other objects that are components of that page 15a. As the cache database management module 29 identifies each component, it initiates a request for the component. The central proxy server 12 then checks to see if the image is already present in the master cache database 24. If it is not, the system 10 initiates a request over the Internet 20 to retrieve that component and continues to do that for every separate object that was indicated as a component of that HTML container object.

This feature provides an additional acceleration to the end user 30. The cache database management module 29 has hopefully retrieved some, if not all, of the component objects that complete a web page by the time that the end user browser 25 has received the original HTML content. The cache database management module 29 preferably begins to analyze and parse the requested object 15 and goes back to the cache database management module 29 and requests all component objects of the web page 15. The entire contents of a web page 15a are then streamed to the web browser 25, without waiting for the web browser to request them individually. Without this read-ahead feature, as it is called, on the cache database management module 29, the browser 25, after receiving the original HTML object, would then be required to request each of the component objects with a separate request, and each of those request would result in a cache request, and subsequently, a request across the Internet. Whereas with the read-ahead feature of the cache database management module, hopefully many of those objects 15 are already in the cache database management module and the client browser 25 receives them automatically or alternatively, receives immediate responses when the browser 25 requests those objects 15.

This “read-ahead” feature is preferably also provided within the central caching module 13. Accordingly, when a cache miss request arrives from a local caching module 17, and the central caching module 13 is requested to retrieve this web object 15, that web object will generally be the initial reference to a particular web page 15. Thus, the object 15 is preferably retrieved by the cache database management module of the central proxy server 12 and handed off to the central caching module 13 along with some identifying information that the received object is an HTML container that may have certain components. The cache database management module 29 of the central proxy server 12 then preferably automatically pre-fetches or pre-locates those components, whether in its local cache or out on the Internet, and notifies the central caching module 13 as each one of those components are identified and located. This allows the central proxy server to be aware of the entire structure of a web page early on.

In one embodiment, the HTML object, together with a list of component objects that accompany the web page 15a are stored together in the cache database management module 29, both of the local proxy servers 22 and the central proxy server 12. The system 10 knows about the digital object, and when it transmits the content of that web page 15, it not only sends the digital object, but it preferably also sends, together therewith, data for all of the component objects that it knows about. When that information arrives, it is passed through to the injector subsystem. Part of those messages will be the container, the information that identifies that particular HTML object and represents the whole page. The container preferably also identifies which of the objects that are being received are component objects of the page 15a.

With that information about which objects comprise a web page, the injector subsystem begins to inject all of those web objects into the local cache, and when it has completed putting all of those objects in, it then informs the local cache 24 of that relationship. In certain embodiments, the grouping information may come first, or it may come last, but at least, under the invention, the local caching module 17 has the opportunity to inform the local cache that these objects all go together and form a logical entity called a web page. This information is preferably used by the local cache to optimize its storage of those objects on the hard disk to keep them in close proximity for later retrieval if need be, so that retrieval time is held to a minimum.

### EXAMPLE OF OPERATION OF THE HYBRID PRIORITY DETERMINATION SCHEME

As discussed, the present invention preferably includes a hybrid heuristic scheme for making a priority determination regarding whether to store received digital objects 15. The local caching modules 17 can be likened to eyes and ears that report what they see to the central caching module 13. The central caching module 13, in turn, aggregates that information, calculates the global popularities of objects, and keeps other information for future use in deciding what to send to local proxy servers 22. Thus, the central caching module 13 collects data regarding what to send out and completes the full feedback loop of observers and a coordinator and distributor of information.

### EXAMPLE OF PRIORITY DETERMINATION AND CONTENT CHURNING PREVENTION

The present invention preferably includes a cache overrun feature, also known as an anti-churning algorithm. As an example of the need for this feature, if a local caching module 17 simply forces large quantities of web objects upon the cache database management module 29, the cache database management module could be forced to discard older, less referenced, objects. Given a sufficiently high rate of injecting objects, eventually fill the local cache becomes filled with information that may or may not be of dramatic interest to that local user base and eventually, extracted digital objects 15 begin being pushed out a back end of the process while other, potentially less popular objects 15 are inserted in the front end.

Thus, if a cache is occupied merely with injecting objects, it is not performing its primary function, which is to retain content. A balancing point is necessary, and the anti-churning algorithm is thus useful for monitoring the objects 15 that are being discarded from the cache, observing which discarded objects are system-delivered objects and which are not, and observing which objects are present in the cache without being multicast from the central proxy server 12. These objects may have been obtained by the local proxy cache got on its own, which may have provide a miss report which was of too low a global priority to be honored.

In other words, for the objects being discarded, we identify which ones are objects that the system 10 did not deliver. We also identify the objects that the system 10 did deliver. From the objects the system 10 did deliver, we identify the global popularity of that object. The relevant amount of system-delivered objects compared to non system-delivered objects may likewise be determined. Using this information, the local proxy server 22 builds up kind of a feedback loop over time to see how the contents of the cache are affected by injecting objects and by pushing objects out. That is, it examines the priorities associated with system-delivered objects and determines a threshold on a priority basis. Objects below that custom-set threshold are not injected into the local cache database management module while objects above the threshold are ensuring that only lower priority objects are displaced.

Web objects are sent by the central caching module 13 on the basis of global popularity, as computed by all of the reports from all the local caching modules 17. Consequently, when a local caching module 17 receives a web object data, attendant to that object is its global popularity rating, which serves as input to the local proxy cache regarding how popular the object might be locally and the local cache can use this information to determine locally how that relates to its own prioritization scheme. So, the feedback loop determines that while objects are inserted into the cache, the cache is predominately discarding everything with a priority of less than, for instance, 2,000 out of 5,000 maximum. This indicates that the higher priority objects were more wanted by that local user base and hence stayed in the local cache. Preferably fuzzy logic is used to establish the threshold. The priority determination can be made quantitatively or qualitatively. This is a way to quantitatively decide what to inject. Significantly, the threshold is set individually and independently by every local proxy server 22.

The content churning algorithm of the present invention thus prevents the contents of that local cache from being overrun by an endless stream of system-delivered objects that may be popular elsewhere, but not necessarily popular locally. It allows the local caching module 17 to continually adjust the threshold to consistently result in injecting only those objects 15 that are most likely to be referenced and used by the local user base. The determination is primarily quantitative in that it does not take into account the actual nature of the content of the objects or the quality of those features, the classification of the contents and what is selective about it.

When serving a diverse user base, in terms of what kind of contents the users want to see, particularly when all of those users are going through the same proxy cache, the content churning algorithm may not be as effective. However, it is considered effective in terms of avoiding overrun in terms of the content selection, and it does allow the local cache to avoid being flooded and to continue to store content that is popular locally.

The algorithm individualizes the threshold for each local proxy server 22. It has been reported that in some installations of the prior art, for example, cache hit rate, which is the primary measure of efficiency and how much value there is to a cache, actually decreases once the satellite delivered digital objects start being injected. This occurs because the globally popular data has little relevance to the local user base, and so much of it is transmitted, that it pushes out other content that the local cache ordinarily would keep around for its user base.

The anti churning algorithm keeps objects from being pushed into the local cache at too fast a rate, and thus prevents wholesale overrun of that local cache. That means that objects that would otherwise stay in the local cache will not be forced out, and in the natural course of events, as determined by that local cache, anything that is injected, if not used by the local user base, it will very quickly be discarded.

The anti-churning algorithm of the present invention can be likened to treating the information over the satellite as water from a fire hydrant. For any particular local cache, rather than be overwhelmed by the flow, we simply put a straw in it and tap just the right amount of flow of information.

### EXAMPLE OF CONTENT LOCALIZATION

Content localization under the present invention involves utilizing a feedback mechanism to heuristically construct a model of the nature of the content that the users of the local cache like or do not like. This requires a system for rating the content. Currently, various commercially available products do this.

These products can integrate with a proxy caches and provide a database that is continually updated on a daily basis. Such products typically provide a sizable database, and categorize and rate websites therein in many different categories. The ratings go beyond identifying pornographic and obscene web sites, and also identify other content such as business sites, educational sites, and so forth.

Preferably, the system 10 establishes a rating for content that is tracked within the system 10. Consequently, everything stored in the central caching module 13 and the central proxy server 12, preferably has an associated rating. This is preferably accomplished by incorporating one of the described content rating products and integrating that product into the system 10.

Once provided with that rating information, the central proxy server 12 sends the content rating with the web object or web page over the satellite 18 and the information is then received by the local caching module 17, which then uses that information in making its own decision whether or not to actually inject that digital object 15 into the local cache 24. The local caching module 17 preferably makes that determination based on analyzing 14 the recent history of the types of digital objects that have been discarded by the local cache. It preferably also looks at the content rating of digital objects that have been discarded and from that determines which areas of content are of the least interest to that user base.

A local proxy server 22 may also be categorized by its primary user base type. For instance, it may be labeled educational, governmental, etc., and may be programmed to make a correlation between the classifications of its type of users at the individual local caching modules 17 and the classification of subject matter of incoming digital objects 15.

Thus, the present invention provides a feedback loop of information regarding the nature of the content being discarded by the local cache. It is significant that every local cache starts out empty. Once it fills up with data, it stays full, and never empties. The purpose of the cache is to hold the most relevant digital objects for the local user base. So, the essence of the content localization and even the anti-churning algorithm involves a feedback loop that monitors what is discarded. That is, the local cache determines what is of highest value to its user base, and determines statistically what kinds of objects both in nature of their content and in their relative priority around the world are most likely to be in demand by that user base. The priority calculation is local. Objects that do end up being injected into the local cache which turn out not to be relevant to the local user base will very quickly lose whatever initial priority status they had and will be discarded by the local cache as other new objects come in.

### EXAMPLE OF LOCAL PRIVATE INTRANET

Individual corporations or companies may under the invention buy a given amount of band width to transmit their corporate Intranet data. The present invention provides several different methods of doing so. One method currently being utilized is to purchase band width at a specific time to download the corporate data.

An alternative, provided under the present invention, is a demand driven system. Working within our current prioritization system, we may maintain priorities for a given Intranet and make sure that the information downloaded is the most pertinent at the given time within that Intranet. Such a system preferably operates on a separate PID (program ID) within the satellite that may be scrambled and secured for that corporate data.

Each PID is different logical channel. The system preferably utilizes total bandwidth across several different PID's at once. Additionally, a single PID doesn't actually reserve a specific amount of bandwidth, but rather is simply a data stream identifier. A corporation with an Intranet may have many web based applications for their employees to use in all of their outer offices, wherever they are, and may take advantage of the same demand driven architecture to have those digital objects prioritized and transmitted as needed to be cached at the local office sites.

### EXAMPLE OF CLUSTERING MECHANISM

One problem encountered is building a central proxy server 12 that is large enough to be highly efficient. If built with too large of a hard drive, it becomes unreasonably expensive, and if not large enough, it becomes hard to gather all the digital objects that are needed.

The solution under the present invention is to create another machine that would be close by the central proxy server 12 and that acts as a local cache. When the central proxy server 12 decides that it needs to delete something for space reasons out of the central proxy server 12, it then sends that digital object 15 using the ICP protocol to this attendant cache server and uses the acquisition time, the time that it took to fetch that object off the Internet, as the priority of that digital object.

The attendant local cache then tends to keep around things that were expensive to get so that next time the central proxy server 12 goes looking for an object, those that were expensive to obtain over the Internet are available immediately, once again using the ICP protocol. The present invention optionally provides multiple local proxy servers 22, each with a different range of priorities or acquisition time, for a scalable cluster of caches.

The present invention places a local caching module 17 on each of the clustered machines. This allows for transmitting the lower priority objects locally using the same format used over the satellite. But in this case it is just targeted directly across a high speed network to the machines local to the central proxy server 12 machine. This allows the system 10 to send the priority of the objects as well. In a nutshell, the cost of acquisition may now be taken into account in the priority scheme of the present invention.

When the system 10 pushes the digital object into the secondary cache which has the local caching module 17 operating in it, a global popularity is provided, and the cache database management module uses that global popularity information to help determine how important it is to keep that object around. In essence, the popularity is not being substituted per se. Indeed, the popularity of the object has clearly fallen down a bit, or it wouldn't have been at the bottom of the priority queue in the central proxy server 12 itself. As a result, in this embodiment, the acquisition time, how long it might take to get this object, is substituted for the global popularity, additionally, size of the object may be considered. If an object is very large, even over a fast network, it may take a significant amount of time to reload the object if it is ever needed. For a small object that is in a very remote part of Chile, for example, which still takes several seconds to get the object would be stored and so that way the things that are most difficult to replace are retained.

### EXAMPLE OF GLOBAL IDENTIFIER

Regarding representing a digital object by a unique identifier, the key to this is that the identifier is much shorter than the URL or any other identifying information of the object thereby making it much easier to maintain a database with the identifiers and their corresponding popularity data. The identifier is assigned by the central proxy server for every object that is stored therein and/or transmitted to the local caching modules 17.

Furthermore the idea of a very short global identifier that is global within the context of the system 10, is considered unique. Being only a few bytes long, it facilitates very efficient reporting from all the local proxy servers 22 when they report object hit counts as described earlier. This enables the present invention to be very efficient in tracking and identifying statistics regarding a particular web object 15, whether on the central proxy server 12 or on local caching module 17. Each local proxy servers 22 reference the same unique global identification number when they receive and report information about a particular web object.

### EXAMPLE OF RACING RETURN OF DATA

When the local cache records an object miss in the local caching module 17, as indicated before, the cache advisor sends a message to the central caching module 13 to the effect of “this local cache doesn't have this object and the users want it.” The central caching module 13 takes that under advisement, so to speak, and decides what it will with it. It may decide to transmit or even re-transmit that object over the satellite depending on the relative priority of that object to all of the other millions of objects it is working with.

It is possible that the response to the user's request may come back over the satellite, and hopefully does so as often as possible. However, if it takes too long, or does not return, the local cache will, itself, also be requesting the information over the standard Internet, all the way to the remote server that has the data. It may receive that digital object back, before any information comes over the satellite. So there are two possible request paths: (1) through the system 10 from the local caching module 17 to central caching module 13 to possible multicast of the digital object 15 over the satellite, or (2) directly from the local cache itself to the content publisher webserver and back. It can then be likened to a race to see which one comes first.

It is important to note that if the local caching module 17 becomes nonfunctional, or the satellite system is disrupted for some reason, the local cache continues to function, albeit at probably a lower efficiency because its going to have to use up more bandwidth upstream as it talks to the Internet. Thus, this redundancy is also a safety factor. The present invention is thus a self-healing system. Moreover, the transmission of requested data is seamless to the user. Due both the race concept and the concept of redundant system, if the satellite becomes inoperative for whatever reason, the user still receives uninterrupted service.

### EXAMPLE OF REDUNDANT TRANSMISSION PATHS

A related aspect to the redundant communication paths for delivering digital objects back to the local cache is that in the event of failure of the satellite communication path, the central caching module 13 can elect to send the digital objects it normally would have transmitted by satellite over the terrestrial Internet. It may have to throttle back on the amount of digital objects that it sends, due to the lack of capability to multicast a single packet of data which is received by many local proxy servers 22 at once. Instead, it sends out one copy of a packet to every local cache, which is a bandwidth consumer. Therefore, in one embodiment, the central proxy server 12 is limited to sending only the most important, most globally popular items when transmitted over terrestrial lines. However, doing so still achieve some measure of operation to assist the local proxy servers 22 until the alternative delivery mechanism, such as a satellite or a multicast backbone comes back on line.

### EXAMPLE OF SLIP-THROUGH TRANSMISSION QUEUES

Referring again to FIG. 8, shown therein is the box labeled transmission queue 346. The transmission queue 346 manages logical messages that represent all of the web objects that have been chosen for transmission. Those objects have been chosen because they have the highest relative priority of all of the objects in the central proxy server 12, and once they have been chosen, they are placed on the transmission queue 346 in the order in which they were chosen. The transmission queue 346 subsystem then preferably starts to gather the actual component parts of the objects. Up until this point the central proxy server 12 has just been manipulating a small data structure, a pointer or tag, that defines each of the objects. The actual digital object is cached by the local cache database management module, but the priority of the object is manipulated using the small data structure that has associated therewith all the relevant information about that object. It is those small data structures that are put onto the transmission queue 346.

When it becomes time to actually access the real data of an object so it can be transmitted, the software of the transmission queue 346 starts with the first object on the queue. The software requests through the API to the cache database management module to “open this object or access and read data from this object”. It goes through this cycle and over time reads as much as it can until it reaches the end of the data for that object.

The process of opening and reading data for an object sometimes is not instantaneous. Sometimes the object data is out on the hard drive of the system, rather than in RAM, and there is usually a latency, of possibly several milliseconds. So if the first object on the transmission queue 346 has initiated these read operations, but there is still no data, then the transmission queue 346 software moves on to the second object and goes through the same process, opening the object for access, reading the data, etc., but now the difference might be that all of that information is in memory and hence the access to it is instantaneous.

What preferably happens under the present invention is that the second object may be transmitted before the first. Or at least as much of it as is available in memory at that time. It will in effect “slip through” the queue up to the front, ahead of the one that technically had a greater priority, simply because the system is not yet able to get the data for that object of higher priority.

The transmission queue 346 preferably continues working down the line of those digital objects and sending digital objects on a basis of what not only has the greatest original priority, but also on a basis of what is available in its entirety. Consequently, at any point during the scan along the queue, certain objects are available, and when there is no further data available for objects of higher priority, then the objects of highest priority that are available get processed into the logical messages, or object messages and are then placed on an output queue. The output queue is then read by the packetizer in the subsystem transmitter across the satellite. The system 10 does its best to send the highest priority digital objects as quickly as it can but it does not wait and waste time if a high priority object is not quite available yet. It takes the next best thing.

### EXAMPLE OF HEURISTICS CONSIDERATION OF TIME SINCE TRANSMISSION

Another unique feature of the system 10 is that the priority calculation in one embodiment takes into account the time since the transmission of an object. Potential items that could be calculated from the cache database management module at the local caching module 17 have been previously discussed. Correspondent to that concept is the priority calculation of the present invention taking into account different informational categories. These categories include those recited previously that can be referenced uniquely from the cache database management module, and specifically, the time since transmission. Additionally, acquisition time, subject matter, and other available information may be taken into account when making a priority determination at the central proxy server 12. Conversely, when making a priority determination at the local cache, the quantitative calculation of the present invention preferably comes into play.

### EXAMPLES OF A BINARY TREE

A further aspect of the present invention is a methodology for maintaining priority of digital objects 15. In one embodiment this methodology comprise the use of a binary tree and a bubbling mechanism. Alternatives include the use of hashing, linear queues, etc., but are not believed to be as efficient as the binary tree and bubbling mechanism.

The system 10 preferably maintains the aforementioned priority queue 342 of all objects 15 that are in the central proxy server 12. It is preferable to keep these objects sorted in order of global popularity. Global popularity may also be referred to herein as “priority.” It should be noted that global popularity and transmission priority may be become slightly separate values at some point. Nonetheless, the queue maintains the objects in need for a priority of transmission or a global popularity index, which in one embodiment are the same.

Regarding the binary tree approach, the sorting key for inserting objects into the tree is the value that results from the priority calculation, combined with a small element of randomization. If the system simply relied upon a priority number that had a fairly small degree of precision, say 6 digit numbers or 4 digit numbers, the possibility of coming up with different objects that all have the same transmission priority would be very high. For example, every object that came in on its first miss would all get the same priority.

The sorting key used under the present invention for each object that is inserted into the binary tree is the result of the priority calculation. However, the least significant digits of that value are replaced with as random number, and the overall priority value is a 32 bit floating point value. This value is transformed into a 32 bit number, and the lower several bits, possibly 8 to 10 bits, are put in a random number, so in place of the lower 10 bits is inserted a random number between 0 and 1,023.

By randomizing object ratings in this manner, the system still maintains the significant part of the priority, the significant portion, reflecting hits and misses on the object. Yet, when objects with what would otherwise be the same value are present, those objects are nonetheless distinguished ever so slightly by the randomization. The randomization is an efficiency that allows the tree to stay balanced, to have a minimal depth. This means that to search for any object, in order for example, to insert or delete the object, the system only has to process at most down to the maximum depth of the tree. If all objects that all have the same priority value were inserted, they would create the equivalent of a rope ladder that would just keep going and going and going. The maximum depth of the tree would get extremely large and at that point, the system would simply be running a linear list, which we have noted is a poor choice for this type of mechanism.

So, by using the randomization, the present invention has very successfully caused the objects to be sorted into the tree and allows the tree to remain fairly well pruned. That is, the tree does not have little branches that go running off. This adds great efficiency to the lookup and the manipulation of objects of the priority queue.

The invention can alternatively employ a balanced binary tree algorithm, such as a red/black tree algorithm, which incorporates additional processing every time you insert or delete an object to detect whether or not surrounding nodes in the tree on certain branches need to be reshuffled in order to avoid the long linear chain. This is considered to be overly complicated, however, for achieving the desired results. Simply randomizing the keys produces that effect automatically on a statistical basis to as much a degree as necessary. This allows the system to use a simple binary tree algorithm which has the fastest possible manipulation time for inserting and deleting objects.

### EXAMPLE OF BUBBLING MECHANISM

Conceptually, using the bubbling mechanism, a large number of objects bubble around in the priority queue in competition to see which gets the highest priority with all of the different hit and miss counts reporting in real time from all of the local proxy servers 22 and affecting the priority ratings of the objects. The objects with the highest priority are transmitted first.

### EXAMPLE OF SELF-ADJUSTING UPLINK RATE TO SPEED OF SATELLITE

In some circumstances, not all requested objects can be transmitted. The amount transmitted is simply a function of the transmission bandwidth available. The present invention has been designed to feed the output to that packetizer module 348 of FIG. 8, which needs to receive the objects just at the right speed to keep the satellite channel full of data. So working backwards in the transmission queue 346 to the priority queue, objects are taken off the top of the priority queue only as fast as they are needed to keep the outgoing bandwidth from having empty spots, which would be wasteful. The present invention is self-adjusting to the speed of the satellite transmission. That is, the rate of providing objects to the transmission queue 346 is adjusted automatically according to the speed of the satellite transmission.

### EXAMPLE OF SELECTIVELY TIMING THE CALCULATION OF PRIORITY

Even though the present invention implements a very efficient algorithm for managing the binary tree that makes up the line structure of the priority queue, a large number of hit and miss reports are generated under the invention, especially hit reports. Once an object has been multicast and delivered everywhere, the system 10 receives mostly hit reports and it is considered advantageous to cut down on the number of times that the system moves an object around on the priority queue.

Every time hits and misses of a particular object are recorded, the calculated priority for that object changes. In one embodiment, each time the priority of an object changes, the object is moved in the priority queue. This involves deleting it from the binary tree and then reinserting it using the new priority as the key value. In a further embodiment, an object is relocated in the queue only every N times that the priority of an object is recalculated. The object may also be relocated if the newly calculated priority has increased a selected amount over what it was the last time the object was moved. This may be based on a percentage increase, or on how quickly the object has increased in priority since the last time it was moved, which would indicate an accelerating interest in this object. Under this embodiment, a balance is struck between moving an object when necessary and not short-changing any object, because it is not being moved every single time a hit is reported. It is preferable not to short-change an object, allowing the objects to move up in priority as rapidly as they deserve, while still saving processor time.

### EXAMPLE OF PRE-DELIVERY OF OBJECTS BASED UPON HISTORICAL ANALYSIS

A further aspect of the present invention is the pre-delivery of objects based on historical analysis. Pre-delivering objects is considered to be a very important part of the whole system, because doing so allows digital objects to be transmitted to local proxy servers 22 before, in many cases, the user base of a local proxy server 22 asks for them. That effect is multiplied and facilitated by having a large number of local proxy servers 22.

The central proxy server 12 and optionally a nearby database machine preferably keep a historical record of the popularity of different web objects, pages, or web sites to a selected degree of resolution. A record is kept of the most popular sites (e.g., the “top 100) for each individual local cache for every 15 minute period during the day. The system 10 analyzes that data and determines over all on a more global or system-wide basis when and where the demand for particular objects is greatest.

In essence, the system 10 examines the daily cycles of usage patterns and determines, for example, that at 6:00 am New York Time, there was a large upswing in demand for Wall Street Journal pages. That demand tapers off in three hours and picks back up in the evening perhaps, slightly, and then it tapers off significantly, almost to nothing during the night time hours, relative to New York. The system in one embodiment analyzes such information, collecting the data for at least one 24 hour period, and then continues to modify it and smooth it over time, using it, deliver time sensitive objects at or before their demand peaks. Continuing the example, Wall Street Journal Pages are delivered just prior to the time they are in high demand. Again, this is a general principal. Preferably, the system 10 pre-delivers the most popular pages just before the times when they have high or peak demands approaching. Doing so provides a significant savings of bandwidth of all the local proxy servers 22 and increases the end user experience, because the new browser responds immediately with the requested web object.

### EXAMPLE OF POPULARITY RATINGS AND HISTORICAL MINING OF DATA

The central proxy server 12 is in one embodiment provided with a software agent that is configured to do analysis. The software agent could even be on a separate machine, if desired. Preferably, a location is provided to store the data and sufficient processing power is provided when needed to analyze it. A communication channel for informing the central proxy server 12 of the objects that it should start working into the priority queue at a certain time is similarly provided. That same database of information can also be mined independently in order to report information back to content publishers or others. For instance, reports can be provided on various patterns of usage of digital objects 15 and so forth. The system 10 can thus provide top 100 ratings, daily usage patterns, things that would help network system engineers plan their network layouts and bandwidth capacities, and the like. Such information may help content publishers redesign their content or distribute it in different ways, such as on different sites to avoid a crunch on any one particular site.

### EXAMPLE OF TRANSMISSION OF LOW PRIORITY DATA

Further novel aspects of the invention include placing a notation on digital objects 15 transmitted over the satellite which are of low priority. For instance, user stations 30 may request a digital object 15, that does not have a sufficient global popularity to be retained, even by the requesting local proxy server 22. Accordingly, a mechanism is provided for the requesting stations to identify low priority web objects that are transmitted in response to their specific requests.

One manner of doing this under the invention is to group a number of local caching modules 17 that have requested a web site, whether that be one or more and when the queuing reaches a priority to where there are sufficient of those to transmit the web page, to then place a tag at the first of the packets, designating the local caching modules 17 that specifically requested the web site. Problematically, however, a further requesting web site may then request the same information right after it was sent over the satellite. The requesting local caching module 17 is not on the exclusive send list. Thus, much like ships passing in the night, the late requester will have received that information or will be receiving it the same time it is requesting it but does not know that it is receiving it.

A solution to this is an alternative manner in which the list of requesting stations is replaced with an infinitely scalable mechanism. The mechanism is much easier to use than keeping a list of the requesting local caching modules 17. This mechanism in one embodiment comprises sending to the designating location in the packet a hashed copy of the URL. The local caching modules 17 correspondingly each keep a list, a revolving list of the URL's requested, preferably also hashed. This list revolves in that once it is full, every new URL that comes in pushes an old URL off the bottom. Accordingly, whenever a new web object comes across the satellite, it is accompanied by a global identification number, popularity information including optionally, meta-data, and the hashed URL.

Of course, the hashed URL could be substituted with the local caching module 17 identification numbers, but the hashed URL is considered to be more effective. The local caching module 17 then compares the hashed URLs on its list against the hashed URL coming across the satellite dish. In this manner the local caching module 17 does not need to unhash the URL as it comes and can make the comparison quickly. In addition, this eliminates the situation where the local caching module 17 sends out a request and subsequently receives an object which it had previously requested but for which the local caching module's ID number is not included thereon.

Use of the hashing algorithm, by it's nature, poses a slight chance of conflicts. Nevertheless, it is believed that at least a 99% success rate of correlating the hashed URL with the URL on the local caching module list will result from the present invention. Thus, transmitting the hashed URL significantly assists in the acceleration of content of the present invention, as the local caching module 17 need not necessarily continually go back to its hit and miss routine to find a requested web object.

### EXAMPLE OF OPERATION OF REDUNDANT CENTRAL PROXY SERVERS

Under the present invention, it is preferred that the central proxy server 12 be provided with a backup in case of failure. In one embodiment, depicted in FIG. 13, the Internet content delivery system 10 of FIG. 1 has been modified to include a plurality of servers 12 each configured redundantly to operate as a central proxy server 12. One server 12 operates as a master 46, while a second server 12, preferably configured substantially in the same manner as the first, operates as a backup 48. While two redundant servers 12 are shown, it should be appreciated that any number of redundant servers 12 may be utilized under the present invention.

The plurality of redundant servers 12 may be co-located and may communicate locally. Nevertheless, for additional safety purposes, it is preferred that the two servers 12 be located geographically remote from each other. So locating the servers 46,48 reduces the possibility that an event, such as a power outing, fire, earthquake, or the like, that might render one server inoperable or unable to communicate with the local proxy servers 22 would also prevent the second server from operating normally. Thus, the servers 12 may be in a separate city, state, or even country from each other. It is preferred that the geographically separated servers 12 communicate over a private communications channel 47, such as a leased T1 line, but, of course, the servers 12 could also communicate over other types of communication mediums, such as the Internet 20. The servers 12 are preferably loosely coupled, maintaining communications over the communications channel 47. Through that communications, the servers 12 preferably synchronize with each other.

One of the servers 12 is preferably in operation as the master 46, while the second is in operation as the backup 48 at all times. The master 46 preferably operates in the manner described herein for the central proxy server 12, while the backup server 48 awaits a failure of the master 46, and upon such failure, assumes the role of the master 46. One server may be dedicated as the master 46, or the plurality of redundant servers 12 may be alternately operated as the master 46.

One problem that the inventors have overcome in operating a redundant server system in conjunction with the Interned content acceleration system 10 of the present invention is that the plurality of servers could conceivably lose contact with each other and could thus lose track of which is operating as the master 46 and which is operating as the backup 48. For instance, the two servers could go down, and come up but fail to establish communications with each other. In such a case, the two servers might both attempt to act as the master 46, confusing the local proxy servers 22. Additionally, a server 12 acting as the master 46 could go off-line, and come back on but fail for some reason to communicate with the other server 12 which is now operating as the master 46. Both could thus believe itself to be the master and attempt to communicate as such with the local proxy servers 22.

To avoid such an occurrence, a redundancy algorithm 49 is preferably provided and operates within each of the redundant servers 12. The redundancy algorithm 49 arbitrates which of the servers is to be the master 46 at any time and which is to be the backup 48. In further embodiments, the redundancy algorithm also provides a methodology for assuring that only one of the servers 46, 48 operates as the master at any one time.

One embodiment of a unique method 550 for maintaining a single master and a single backup at any one time is illustrated in FIG. 14. The method 550 of FIG. 14 starts at a step 552 and progresses to a step 554, where the server 12 on which the method 550 is operating receives a token. The token may be stored within the server or may be provided to the server 12 manually or from another redundant server 12. The token is preferably used to indicate whether the server 12 is to operate as the master 46 or the backup 48 and for use in notifying the local proxy servers 22 which of the redundant servers 12 is the master 46.

At a step 556, the two servers 12 communicate with each other to arbitrate which is to operate currently as the master and which is to operate as the backup. Because both servers 46,48 preferably communicate with each to maintain substantially the same content, this decision may be arbitrary. It may also be based upon which of the servers has had the majority of up-time, preserving the longevity of the servers, or which has the greatest capacity. For instance, if one server has less storage space than the other, it may be generally operated in backup mode.

This decision is made at a decision step 558, where the method 550 branches. If the server 46, 48 is to operate as the master, the method 550 branches to a step 560. At the step 560, the token is preferably synchronized between the two servers 12. Thus, the servers 46, 48 may at this stage contain identical tokens. At a step 562, the token is transmitted from the server 12 to the local proxy servers 22. The local proxy servers 22 are thus informed as to which of the servers 46, 48 is the master. The server 12 then operates normally, as indicated at a step 564. This operation is, in one embodiment, as described above with respect to FIGS. 1-12.

The server 12 operates normally until a failure occurs as indicated at a step 566. When a failure occurs, the backup server 48 will typically lose communications with the master 46 and will assume the role of master 46. Accordingly, the server 12 maintains its state upon such a failure, typically with CMOS memory, and restarts at a step 568 when the event that caused the off-line condition to occur is rectified. The server 12 then establishes communication with the other server(s) 12, one of which has been acting as the master 46 in its absence, and arbitrates which of the servers 12 is to continue as the master 46 at a step 570. The method 550 then returns to the step 558.

Returning to the step 558, if the decision therein is that the server 12 is to be the backup 48, then the method 550 progresses to a step 571. At the step 571, the tokens are synchronized between the two servers 12. As indicated at a step 572, the server 12 continually receives updates from the master 46 over the communication medium 47. Thus, the two (or more) servers 12 are maintained with substantially identical contents. The backup 48 also continually monitors communications with the master 46, and if those communications cease for a selected amount of time, for example, 20 seconds, the backup 48 will deem that the master 46 has failed and gone off-line.

The server 12 then increments the token as indicated at a step 576. The token is then transmitted to the local proxy caches at a step 578, informing the local proxy caches 22 that the server 12 is now the master 46. If the local proxy caches receive two versions of the token, because, for instance, both servers 12 are operating, but cannot establish communication with each other to arbitrate which is to be the master, the server 12 with the token that has the highest value is deemed by the local proxy caches 22 to be the master 48.

The server 12 then changes mode to operation as the master 48 as indicated at a step 580 and operates as the master server 46 until communications can be established with the other server 12 as indicated at a step 582. When this happens, the servers 12 once again arbitrate which of the servers 12 will be the master as indicated at a step 584, and the method 550 returns to the step 558. The method 550 operates upon each redundant server 12, and continually loops until the server 12 is shut down by an operator, at which point the method 550 terminates.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters patent is:

1. A system for accelerating delivery of digital objects of a global communications network, the system comprising:
a central proxy server configured to transmit selected digital objects over a communication medium;
a local proxy server configured to receive the selected digital objects from the central proxy server over the communication medium and to provide the selected digital objects to a caching database in local communication with the local proxy server in order to make the selected digital objects available to a plurality of user stations communicating with the caching database; and
a priority determination module operating within the local proxy server, the priority determination module configured to use both local priority data and global priority data in making a localized priority determination regarding digital objects stored in the caching database.

2. The system of claim 1, wherein the local proxy server is configured to utilize the localized priority determination to determine which digital objects transmitted by the central proxy server to store within the caching database.

3. The system of claim 1, wherein the local proxy server is configured to utilize the localized priority determination in selecting digital objects to discard.

4. The system of claim 1, further comprising a plurality of local proxy servers each configured to receive the selected digital objects from the central proxy server over the communication medium, each of the plurality of local proxy servers provided with a priority determination module configured to make a localized priority determination particular to the nature of the user stations of the central proxy server for which the priority determination module is provided.

5. The system of claim 1, wherein the localized priority determination utilizes local demand data received from the caching database in making the localized priority determination.

6. The system of claim 1, wherein the priority determination module considers both local demand data received from the caching database and global demand data received from the central proxy server in making the localized priority determination.

7. The system of claim 1, wherein the local proxy server is configured to receive local demand data from the caching database and transmit the local demand data to the central proxy server.

8. The system of claim 7, wherein the local demand data comprises user requests for a particular digital object.

9. The system of claim 8, wherein the user requests comprise requests for a digital object located within the caching database of the local proxy server.

10. The system of claim 1, wherein the central proxy server is configured to receive local demand data from a plurality of local proxy servers, generate global demand data using the local demand information, and transmit the global demand data to at least one of the local proxy servers.

11. The system of claim 10, wherein the global demand data corresponding to a selected digital object is transmitted together with the selected digital object to the local proxy server.

12. The system of claim 1, wherein the priority determination module is configured to account for types of subject matter that are of interest to users of the user stations communicating with the local proxy server in making the determination whether to discard the digital objects, and wherein the global demand data includes an indication of the type of subject matter of digital objects being transmitted from the central proxy server.

13. The system of claim 1, wherein the priority determination module is configured to employ a policy for assigning selected weights to particular types of digital objects in making the localized priority determination, the policy being unique to the local proxy server.

14. The system of claim 1, wherein the central proxy server is further configured to assign all selected digital objects a unique identifier code and to transmit a unique identifier code over the communication medium with each selected digital object.

15. The system of claim 14, wherein the central proxy server is further configured to generate a popularity rating for each transmitted digital object and to correlate the popularity rating with the corresponding unique identifier code for each transmitted digital object.

16. The system of claim 1, wherein the local proxy server is further configured to respond to a request from a communicating user station for a digital object available at a remote location on the global communication network by determining whether the information is present in the caching database and if the information is present, transmitting the requested information to the user station, and if the information is not present, transmitting a notification to the central proxy server that the information was requested by a user station.

17. The system of claim 1, wherein the communication medium comprises an IP multicast system.

18. The system of claim 1, wherein the communication medium comprises multicast distribution of the digital objects through geo-synchronous satellite transmission.

19. The system of claim 1, wherein the local proxy server further comprises:
a cache database management module operating within the caching database; and
a local caching module operating within the local proxy server and in integral communication with the cache database management module, the local caching module configured to receive notice that the selected digital objects have been received from the communication medium and instruct the cache database management module to store at least a portion of the selected digital objects within the caching database.

20. The system of claim 19, further comprising an application program interface (API), the local caching module in communication with the cache database management module through the API.

21. A method for accelerating delivery of digital content of a global communications network, the method comprising:
transmitting selected digital objects over a communication medium;
receiving the selected digital objects over the communication medium into a caching database of a local proxy server for later retrieval and transmission to user stations; and
making a determination whether to discard digital objects from the caching database and considering both local demand data from the caching database and global demand data from the central proxy server in making the determination.

22. A method for accelerating delivery of digital content of a global communications network, the method comprising:
extracting selected digital objects from a global communications network;
transmitting the selected digital objects over a communication medium;
receiving the selected digital objects over the communication medium into a caching database of a local proxy server for later retrieval and transmission to user stations;
integrally communicating with a cache database management module to store the selected digital objects in a caching database;
receiving a request from a user station for information available at a remote location on the global communications network;
making a determination whether to discard digital objects from the caching database and considering both local demand data received the caching database and global demand data from the central proxy server in making the determination; and
integrally communicating with the cache database management module to check for the information among the selected digital objects and making the information available for forwarding to the user station if present among the selected digital objects.

23. A method for operating redundant proxy servers, the method comprising:
providing a plurality of redundant proxy servers, each redundant proxy server similarly configured;
providing a token to the redundant proxy servers;
selecting one of the redundant proxy servers as a master and a second as a backup;
establishing a failure of communication with the master by the backup, and in response:
incrementing the token within the backup,
transmitting the backup's token to the client stations;
the backup assuming operation as the master.

24. A method for accelerating delivery of digital content of a global communications network, the method comprising:
transmitting a digital object over a communication medium from a cental proxy server;
receiving the digital object over the communication medium into a local proxy server;
receiving notification from a local cache attendant to the local proxy server that the digital object is out of date;
transmitting notice to the central proxy server that the object is out of date;
retransmitting a newer version of the object from the central proxy server to the local proxy server.

25. The method of claim 24, further comprising maintaining a transmission queue at the central proxy server with other digital objects to be transmitted to the local proxy server ordered in the queue, and the central proxy server receiving the transmitted notice that the object is out of date and in response, obtaining the newer version of the object and placing the newer version of the object in the queue with a higher priority than the object would have had absent the notice that the object is out of date.

26. A method for accelerating delivery of digital content of a global communications network, the method comprising:
transmitting a digital object over a communication medium from a central proxy server;
receiving the digital object over the communication medium into a caching database of a local proxy server for possible later retrieval and transmission to user stations; and
making a determination whether to retain the digital object within the caching database, making the determination comprising considering both quantitative and qualitative information about the object.

27. The method of claim 26, wherein the qualitative information comprises statistics about the nature of objects discarded from the caching database.

28. The method of claim 27, further comprising gathering the statistics about the nature of objects discarded from the caching database locally within the local proxy server.
